(19) United States
(12) Patent Application Publication
(10) Pub. No.: US 2023/0023289 A1
(43) Pub. Date: Jan. 26, 2023

(54) ANTHRANILAMIDE COMPOSITION

(71) Applicants: FMC Corporation, Philadelphia, PA (US); FMC Agro Singapore Pte. Ltd., Singapore (SG)

(72) Inventors: Chungeng NI, Shanghai (CN); Hao LONG, Shanghai (CN); Jinhua SHI, Shanghai (CN); Yonggui XU, Shanghai (CN); Shuai ZHENG, Shanghai (CN)

(21) Appl. No.: 17/764,195

(22) PCT Filed: Sep. 26, 2020
(86) PCT No.: PCT/US2020/052971

§ 371 Date: Mar. 27, 2022

Related U.S. Application Data
(60) Provisional application No. 62/906,801, filed on Sep. 27, 2019.

(51) Int. Cl. A01N 41/04; A01N 43/56; A01N 33/20; A01N 43/40

(52) U.S. Cl. CPC A01N 41/04; A01N 43/56; A01N 33/20; A01N 43/40

(57) ABSTRACT

The present disclosure provides an agrochemical composition comprising a pesticidal active ingredient, an enhancer comprising a salt of dialkylsulfosuccinate, a salt of lauryl sulfate, a salt of lauryl benzene sulfonate, fatty alcohol derivative, a salt of alkyl naphthyl sulphonate, or a salt of alkylnaphthyl sulphate, or a mixture thereof, and a dispersing agent comprising polycarboxylate, phenol sulfonic acid condensation, polyoxypropylene-polyoxyethylene block copolymer, or naphthalene sulfonic acid condensation, or a mixture thereof. The invention also provides a method for controlling pests in a crop, comprising applying an agriculturally effective amount of said composition to the crop in need thereof or its environment.

### CROSS-REFERENCE TO RELATED APPLICATION

This application claims the benefit of U.S. Provisional Application No. 62/906,801 filed Sep. 27, 2019.

### FIELD OF THE INVENTION

The present disclosure relates to a novel composition comprising an anthranilamide and a method comprising applying said composition for controlling pests.

### BACKGROUND

Anthranilamides (also known as anthranilic diamides) are an important synthetic class of insecticides that affect calcium homeostasis with high selectivity for the insect ryanodine receptor over the mammalian receptors. Among others, chlorantraniliprole is the most widely used insecticide in that class. It has high biological activity against pests belonging to the Order Lepidoptera and some Coleoptera, Diptera and Isoptera species, and very low toxicity to non-target arthropods. Chlorantraniliprole is active on chewing pest insects primarily by ingestion and secondarily by contact.

Commonly developed formulation types of chlorantraniliprole include suspension concentrate (SC), water-dispersible granules (WDG), flowable concentrate for seed coating (FS), and granules (GR). These pesticidal formulations are often applied via a spray. Manually spraying pesticides as aqueous solutions or suspensions is labor-intensive and time-consuming. Current labor-saving technologies, such as ultra-low volume (ULV) and aircraft sprays are restricted by the requirement of higher technical skills and cost of equipment, and thus are not always feasible for standard grower applications. ULV and aircraft sprays may also be associated with the issue of wind drift depending on weather conditions at the time of spraying, where pesticides may potentially enter into the environment. Therefore, it is highly desirable to develop novel pesticide formulations that are easy to apply by growers and farmers and demonstrate a high level of pest-controlling effect with reduced environmental load.

### SUMMARY OF INVENTION

The inventors of the present disclosure have found that when an anthranilamide as an active ingredient is formulated with a suitable combination of one or more dispersing agent and one or more enhancer, the formulation achieves desired homogenously dispersing effect without using equipment, thereby liberating farmers from the time- and labor-consuming manual spray. It is herein provided a novel composition, e.g., in tablet form, that disperses homogenously when thrown directly, for example, into a rice paddy field, and obtains a higher efficacy of pest control under recommended dosage.

In one aspect, the present disclosure provides herein a formulation comprising a composition comprising:

(a) a pesticidal active ingredient;

(b) an enhancer, wherein the enhancer comprises a salt of dialkylsulfosuccinate, a salt of lauryl sulfate, a salt of lauryl benzene sulfonate, fatty alcohol derivative, a salt of alkyl naphthyl sulphonate, or a salt of alkylnaphthyl sulphate, or a mixture thereof;

(c) a dispersing agent, wherein the dispersing agent comprises polycarboxylate, phenol sulfonic acid condensation, polyoxypropylene-polyoxyethylene block copolymer, or naphthalene sulfonic acid condensation, or a mixture thereof;

(d) a binder; and

(e) optionally a filler.

In one aspect, the present disclosure provides herein a formulation comprising a composition comprising by weight based on the total weight of the composition:

(a) about 0.1% to about 20% of a pesticidal active ingredient;

(b) about 0.1% to about 5% of at least one enhancer, wherein the enhancer comprises a salt of dialkylsulfosuccinate, a salt of lauryl sulfate, a salt of lauryl benzene sulfonate, fatty alcohol derivative, a salt of alkyl naphthyl sulphonate, or a salt of alkylnaphthyl sulphate, or a mixture thereof;

(c) about 0.1% to about 10% of at least one dispersing agent, wherein the dispersing agent comprises polycarboxylate, phenol sulfonic acid condensation, polyoxypropylene-polyoxyethylene block copolymer, or naphthalene sulfonic acid condensation, or a mixture thereof;

(d) about 0.1% to about 20% of at least one binder; and

(e) about 0.1% to about 50% of at least one filler.

In certain embodiments, the composition is in the form of a tablet.

In certain embodiments, the pesticidal active ingredient is a herbicide or insecticide. In certain embodiments, the pesticidal active ingredient is a diamide, neonicotinoid, or nereistoxin analogue insecticide, or a mixture thereof. In certain embodiments, the pesticidal active ingredient is a diamide.

In certain embodiments, the composition further comprises by weight based on the total weight of the composition component (f) about 0.1% to about 40% of at least one acid and/or (g) about 0.1% to about 40% of at least one alkali.

In certain embodiments, the enhancer comprises sodium dialkylsulfosuccinate, sodium lauryl sulfate, sodium lauryl benzene sulfonate, fatty alcohol derivative, sodium alkyl naphthyl sulphonate, diocyl sodium sulfosuccinate, or alkylnaphthyl sodium sulphate, or a mixture thereof.

In one aspect, the present disclosure provides a tablet composition comprising by weight based on the total weight of the composition:

(a) about 0.1% to about 20% of a pesticidal active ingredient comprising one or more anthranilamide;

(b) about 0.1% to about 5% of at least one enhancer, wherein the enhancer comprises a salt of dialkylsulfosuccinate, a salt of lauryl sulfate, a salt of lauryl benzene sulfonate, fatty alcohol derivative, a salt of alkyl naphthyl sulphonate, or a salt of alkylnaphthyl sulphate, or a mixture thereof.

(c) about 0.1% to about 10% of at least one dispersing agent, wherein the dispersing agent comprises polycarboxylate, phenol sulfonic acid condensation, polyoxypropylene-polyoxyethylene block copolymer, or naphthalene sulfonic acid condensation, or a mixture thereof.

(d) about 0.1% to about 20% of at least one binder; and

(e) about 0.1% to about 50% of at least one filler.

In certain embodiments, the pesticidal active ingredient is herbicide or insecticide. In certain embodiments, the pesticidal active ingredient is a diamide, neonicotinoid, or nereistoxin analogue insecticide, or a mixture thereof.

In certain embodiments, the component (a) comprises chlorantraniliprole, cyantraniliprole, tetraniliprole, cyclaniliprole, cyhalodiamide, tetra-chlorantraniliprole, thiamethoxam, clothianidin, thiacloprid, monosultap, or bisultap, or a mixture thereof. In certain embodiments, the component (a) comprises chlorantraniliprole.

In certain embodiments, the component (a) is from about 1% to about 10%, about 1% to about 8%, about 1% to about 7%, about 1% to about 6%, about 1% to about 5.5%, about 1%, about 2.5% or about 5% of the composition by weight.

In certain embodiments, the enhancer comprises sodium dialkylsulfosuccinate, sodium lauryl sulfate, sodium lauryl benzene sulfonate, fatty alcohol derivative, sodium alkyl naphthyl sulphonate, diocyl sodium sulfosuccinate, or alkylnaphthyl sodium sulphate, or a mixture thereof. In certain embodiments, the enhancer comprises a salt of dioctyl sulfosuccinate.

In certain embodiments, the component (b) comprises Geropon® SDS, Aerosol® OT-B, or Aerosol® OT-75, or a mixture thereof. In certain embodiments, the component (b) is one substance selected from the group consisting of Geropon® SDS, Aerosol® OT-B, and Aerosol® OT-75. In certain embodiments, the component (b) comprises Geropon SDS. In certain embodiments, the component (b) is Geropon® SDS.

In certain embodiments, the component (b) is about 0.1% to about 4%, about 0.1% to about 3%, about 0.1% to about 2%, about 0.2% to about 2%, about 0.3% to about 2%, about 0.3% to about 1.8%, about 0.3% to about 1.5%, about 0.3% to about 1.2%, about 0.3% to about 1%, about 0.5% to about 1%, about 0.6% to about 1%, about 0.7% to about 1%, or about 0.8% of the composition by weight.

In certain embodiments, the component (c) comprises Tersperse® 2700, Atlox Metasperse™ 550 S, Geropon® Ultrasperse, Duramax® D-205, or Geropon® T/36, or a mixture thereof. In certain embodiments, the component (c) is one substance selected from the group consisting of Tersperse® 2700, Atlox Metasperse™ 550 S, Geropon® Ultrasperse, Duramax® D-205, and Geropon® T/36. In certain embodiments, the component (c) comprises Tersperse® 2700. In certain embodiments, the component (c) is Tersperse® 2700.

In certain embodiments, the component (c) is about 0.5% to about 10%, about 0.5% to about 8%, about 0.5% to about 7%, about 0.5% to about 6%, about 0.5% to about 5%, about 0.8% to about 5%, about 1% to about 5%, about 1.2% to about 5%, about 1.5% to about 5%, about 1.7% to about 5%, about 2% to about 5%, about 2% to about 4.5%, about 2% to about 4%, about 2% to about 3.5%, about 2% to about 3%, about 2.2% to about 2.8%, about 2.4% to about 2.6%, or about 2.5% of the composition by weight.

In certain embodiments, the composition further comprises component (f) about 0.1% to about 40% of at least one acid and/or (g) about 0.1% to about 40% of at least one alkali.

In certain embodiments, the component (f) comprises at least one substance selected from the group consisting of citric acid, malonate, adipic acid, maleic acid and D,L-tartaric acid. In certain embodiments, the component (f) comprises D,L-tartaric acid. In certain embodiments, the component (f) is D,L-tartaric acid.

In certain embodiments, the component (f) is about 0.5% to about 25%, about 1% to about 25%, about 5% to about 25%, about 10% to about 25%, about 15% to about 25%, about 16% to about 25%, about 17% to about 25%, about 18% to about 25%, about 19% to about 25%, about 20% to about 25%, about 20% to about 24%, about 20% to about 23%, about 20% to about 22%, or about 21% of the composition by weight.

In certain embodiments, the component (g) comprises at least one substance selected from the group consisting of bicarbonates and carbonates. In certain embodiments, the component (g) comprises at least one substance selected from the group consisting of sodium bicarbonates, potassium bicarbonate, sodium carbonates, and potassium carbonate. In certain embodiments, the component (g) comprises a mixture of sodium bicarbonates and sodium carbonates. In certain embodiments, the component (g) is a mixture of sodium bicarbonates and sodium carbonates.

In certain embodiments, the ratio of sodium bicarbonates and sodium carbonates, or the ratio of potassium bicarbonates and potassium carbonates is about 1:10-10:1, about 1:5-10:1, about 1:3-10:1, about 1:2-10:1, about 1:1-10:1, about 2:1-10:1, about 3:1-10:1, about 3:1-9:1, about 3:1-8:1, about 3:1-7:1, about 3:1-6:1, about 3:1-5:1, about 3:1-4:1, about 3.5:1-4:1, or about 3.7:1 by weight.

In certain embodiments, the component (g) comprises a mixture of sodium bicarbonate and sodium carbonate, wherein the sodium bicarbonate is about 0.5% to about 40%, about 1% to about 40%, about 5% to about 40%, about 10% to about 40%, about 15% to about 40%, about 20% to about 40%, about 25% to about 40%, about 25% to about 35%, about 27% to about 33%, or about 30% of the composition by weight and the sodium carbonate is about 1% to about 40%, about 1% to about 30%, about 1% to about 20%, about 2% to about 20%, about 3% to about 20%, about 3% to about 18%, about 3% to about 15%, about 3% to about 12%, about 3% to about 10%, about 5% to about 10%, about 6% to about 10%, about 7% to about 10%, or about 8% of the composition by weight.

In certain embodiments, the component (g) comprises a mixture of potassium bicarbonate and potassium carbonate, wherein the potassium bicarbonate is about 0.5% to about 40%, about 1% to about 40%, about 5% to about 40%, about 10% to about 40%, about 15% to about 40%, about 20% to about 40%, about 25% to about 40%, about 25% to about 35%, about 27% to about 33%, or about 30% of the composition by weight and the potassium carbonate is about 1% to about 40%, about 1% to about 30%, about 1% to about 20%, about 2% to about 20%, about 3% to about 20%, about 3% to about 18%, about 3% to about 15%, about 3% to about 12%, about 3% to about 10%, about 5% to about 10%, about 6% to about 10%, about 7% to about 10%, or about 8% of the composition by weight.

In certain embodiments, the component (g) is about 0.5% to about 40%, about 1% to about 40%, about 5% to about 40%, about 10% to about 40%, about 15% to about 40%, about 20% to about 40%, about 25% to about 40%, about 30% to about 40%, about 35% to about 40%, or about 38% of the composition by weight.

In certain embodiments, the component (d) comprises at least one substance selected from the group consisting of polyethylene glycol (PEG), maltose, trehalose, sorbitol, maltitol, polyvinylpyrrolidone, dibasic calcium phosphate, sucrose, glucose, corn (maize) starch, modified cellulose, alginic acid, carboxymethylcellulose sodium, and copovidone. In certain embodiments, the component (d) comprises PEG. In certain embodiments, the component (d) is PEG. In certain embodiments, the PEG is one selected from the group consisting of PEG2000, PEG4000, PEG6000, PEG8000 and PEG10000. In certain embodiments, the PEG is PEG 6000.

In certain embodiments, the component (d) is about 1% to about 15%, about 1% to about 10%, about 1% to about 8%, about 1% to about 7%, about 1% to about 6%, about 1% to about 5.5%, about 2% to about 5.5%, about 3% to about 5.5%, about 3%, or about 5.5% of the composition by weight.

In certain embodiments, the component (e) comprises at least one substance selected from the group consisting of lactose, lactose monohydrate, mannitol, sucrose, talcum, maltodextrin, dextrin, maltitol, sorbitol, xylitol, powdered cellulose, cellulose gum, microcrystalline cellulose, starch, or calcium phosphate. In certain embodiments, the component (e) comprises talcum, or maltodextrin, or a mixture thereof. In certain embodiments, the component (e) comprises a mixture of talcum and maltodextrin. In certain embodiments, the component (e) comprises about 1% to about 15%, about 1% to about 10%, about 1% to about 8%, about 2% to about 8%, about 3% to about 8%, about 4% to about 8%, about 5% to about 8%, about 6% to about 8%, or about 6% of the composition by weight of talcum, and about 1% to about 40%, about 1% to about 30%, about 5% to about 30%, about 8% to about 30%, about 10% to about 30%, about 15% to about 30%, about 18% to about 30%, about 18% to about 27%, or about 20% to about 27% of the composition by weight of maltodextrin.

In certain embodiments, the component (e) is about 0.5% to about 50%, about 1% to about 50%, about 5% to about 50%, about 10% to about 50%, about 15% to about 50%, about 20% to about 50%, about 20% to about 45%, about 20% to about 40%, about 20% to about 35%, about 25% to about 35%, about 26% to about 33%, about 26%, about 29% or about 33% of the composition by weight.

In certain embodiments, the composition further comprises component (h) of about 0.1% to about 5% of the composition by weight of at least one lubricant.

In certain embodiments, the component (h) comprises at least one substance selected from the group consisting of white carbon, talcum powder, magnesium stearate, calcium stearate, sodium stearate, zinc stearate, stearic acid, metallic stearate, sodium stearyl fumarate, fatty acid, fatty alcohol, fatty acid ester, glyceryl behenate, canola oil, mineral oil, vegetable oil, glyceryl palmitostearate, hydrogenated vegetable oil, hydrogenated vegetable oil, magnesium oxide, poloxamer, paraffin, leucine, propylene glycol fatty acid ester, polyvinyl alcohol sodium benzoate, sodium lauryl sulfate, sodium stearyl fumarate, polyethylene glycol, polypropylene glycol, and polyalkylene glycol. In certain embodiments, the component (h) comprises stearate. In certain embodiments, the component (h) is stearate. In certain embodiments, the component (h) comprises magnesium stearate. In certain embodiments, the component (h) is magnesium stearate.

In certain embodiments, the component (h) is about 0.1% to about 4.5%, about 0.1% to about 4.0%, about 0.1% to about 3.5%, about 0.1% to about 3.0%, about 0.1% to about 2.5%, about 0.1% to about 2.0%, about 0.1% to about 1.5%, about 0.1% to about 1.0%, about 0.5% to about 1.0%, about 0.5% to about 0.7%, about 0.5%, or about 0.7% of the composition by weight.

In certain embodiments, the composition further comprises component (i) of about 0.01% to about 5% of the composition by weight of at least one bitter.

In certain embodiments, the component (i) comprises at least one substance selected from the group consisting of benzodiazepine, denatonium, sucrose octaacetate, quercetin, brucine and quassin. In certain embodiments, the component (i) comprises denatonium benzoate.

In certain embodiments, the component (i) is about 0.01% to about 4.5%, about 0.01% to about 4.0%, about 0.01% to about 3.5%, about 0.01% to about 3.0%, about 0.01% to about 2.5%, about 0.01% to about 2.0%, about 0.01% to about 1.5%, about 0.01% to about 1.0%, about 0.01% to about 0.5%, about 0.01% to about 0.4%, about 0.01% to about 0.3%, about 0.01% to about 0.2%, about 0.01% to about 0.1%, about 0.01% to about 0.05%, about 0.05%, about 0.1% of the composition by weight.

In certain embodiments, the composition further comprises component (j) of about 0.1% to about 1.5% of the composition by weight of at least one dispersant.

In certain embodiments, the component (j) comprises at least one substance selected from the group consisting of dysperse 131, polyfon H, disperse 132, and disperse 140. In certain embodiments, the component (i) comprises polyfon H.

In certain embodiments, the component (j) is about 0.1% to about to about 4.0%, about 0.1% to about 3.5%, about 0.1% to about 3.0%, about 0.1% to about 2.5%, about 0.1% to about 2.0%, about 0.1% to about 1.5%, about 0.1% to about 1.0%, about 0.1% to about 0.5%, about 0.1% to about 0.4%, about 0.1% to about 0.3%, about 0.1% to about 0.2%, about 0.1% to about 0.1%, about 0.1% to about 0.5%, about 0.5%, about 1.0% of the composition by weight.

In one aspect, the present disclosure provides herein a tablet composition comprising by weight based on the total weight of the composition:
(a) about 0.1% to about 20% of chlorantraniliprole, or cyantraniliprole, or mixture thereof;
(b) about 0.1% to about 5% of Geropon® SDS;
(c) about 0.1% to about 10% of Tersperse® 2700;
(d) about 0.1% to about 20% of PEG-6000;
(e) about 0.1%-50% of a mixture comprising talcum and maltodextrin;
(f) about 0.1%-40% of D,L-tartaric acid; and
(g) about 0.1% to about 40% of a mixture comprising sodium bicarbonate and sodium carbonate.

In one aspect, the present disclosure provides herein a tablet composition comprising by weight based on the total weight of the composition:
(a) about 1%-5.5% of chlorantraniliprole, or cyantraniliprole, or a mixture thereof;
(b) about 0.5%-1.8% of Geropon® SDS;
(c) about 1.5%-3.5% of Tersperse® 2700;
(d) about 1%-8% of PEG-6000;
(e) about 3%-8% of talcum and about 20-30% of maltodextrin;
(f) about 15%-25% of D,L-tartaric acid; and
(g) about 20%-40% of sodium bicarbonate and about 5-10% of sodium carbonate.

In certain embodiments, the composition further comprises (h) about 0.5% to about 0.7% of magnesium stearate. In certain embodiments, the composition further comprises (i) about 0.04% to about 0.06% of denatonium benzoate. In certain embodiments, the composition further comprises (i) about 0.06% to about 0.12% of denatonium benzoate. In certain embodiments, the composition further comprises component (j) of about 0.1% to about 1.5% of the composition by weight of at least one dispersant.

In one aspect, the present disclosure provides herein a tablet composition comprising by weight based on the total weight of the composition:
(a) about 1.05% of chlorantraniliprole;
(b) about 0.8% of Geropon® SDS;
(c) about 2.5% of Tersperse® 2700;
(d) about 3.0% of PEG-6000;
(e) about 6.0% of talcum and about 27.1% of maltodextrin;
(f) about 21% of D,L-tartaric acid; and
(g) about 30% of sodium bicarbonate and about 8% of sodium carbonate.

In certain embodiments, the composition further comprises (h) about 0.5% of magnesium stearate. In certain embodiments, the composition further comprises (i) about 0.05% of denatonium benzoate. In some embodiments, the composition further comprises (i) about 0.1% of denatonium benzoate. In certain embodiments, the composition further comprises component (j) of about 1.0% of polyfon H.

In one aspect, the present disclosure provides herein a tablet composition comprising by weight based on the total weight of the composition:
(a) about 2.6% of chlorantraniliprole;
(b) about 0.8% of Geropon® SDS;
(c) about 2.5% of Tersperse® 2700;
(d) about 5.5% of PEG-6000;
(e) about 6.0% of talcum and about 22.85% of maltodextrin;
(f) about 21% of D,L-tartaric acid; and
(g) about 30% of sodium bicarbonate and about 8% of sodium carbonate.

In certain embodiments, the composition further comprises (h) about 0.7% of magnesium stearate. In certain embodiments, the composition further comprises (i) about 0.05% of denatonium benzoate. In certain embodiments, the composition further comprises (i) about 0.1% of denatonium benzoate. In certain embodiments, the composition further comprises component (j) of about 1.0% of polyfon H.

In one aspect, the present disclosure provides herein a tablet composition comprising by weight based on the total weight of the composition:
(a) about 5.1% of chlorantraniliprole;
(b) about 0.8% of Geropon® SDS;
(c) about 2.5% of Tersperse® 2700;
(d) about 5.5% of PEG-6000;
(e) about 6.0% of talcum and about 20.35% of maltodextrin;
(f) about 21% of D,L-tartaric acid; and
(g) about 30% of sodium bicarbonate and about 8% of sodium carbonate.

In certain embodiments, the composition further comprises (h) about 0.7% of magnesium stearate. In certain embodiments, the composition further comprises (i) about 0.05% of denatonium benzoate. In certain embodiments, the composition further comprises (i) about 0.1% of denatonium benzoate. In certain embodiments, the composition further comprises component (j) of about 1.0% of polyfon H.

In another aspect, the present disclosure provides herein a method for controlling pests in a crop, comprising applying an agriculturally effective amount of the formulation or composition provided herein to the crop in need thereof or its environment.

In certain embodiments, the formulation or composition is applied at a rate of 10 grams active ingredient per hectare (gai/ha) to about 10,000 gai/ha, about 10 to about 5,000 gai/ha, about 10 to about 1,000 gai/ha, about 10 to about 500 gai/ha, about 10 to about 200 gai/ha, about 10 to about 100 gai/ha, about 10 to about 90 gai/ha, about 10 to about 80 gai/ha, about 10 to about 70 gai/ha, about 10 to about 60 gai/ha, about 10 to about 50 gai/ha, about 20 to about 50 gai/ha, about 30 to about 50 gai/ha, or about 40 gai/ha.

In certain embodiments, a single tablet of the present disclosure comprises about 0.0004 g to about 1 g, about 0.001 g to about 0.5 g, about 0.002 g to about 0.4 g, about 0.003 g to about 0.3 g, about 0.004 g to about 0.2 g, about 0.005 g to about 0.2 g, about 0.01 g to about 0.3 g, about 0.05 g to about 0.3 g, about 0.07 g to about 0.3 g, about 0.1 g to about 0.3 g, about 0.1 g to about 0.25 g, about 0.1 g to about 0.2 g, about 0.0034 g, about 0.0775 g, or about 0.15 g of component (a).

In certain embodiments, the crop is selected from a group consisting of rice, vegetable and corn. In certain embodiments, the crop is rice. In certain embodiments, the crop is rice and the formulation or composition is applied to a paddy field.

### BRIEF DESCRIPTION OF THE DRAWINGS

FIG. 1 shows the sampling positions where the active ingredient was collected for examining the distribution profile of the tablets.

FIG. 2 shows the content of the active ingredient in the sampling positions.

FIG. 3 shows the concentration of chlorantraniliprole absorbed in rice stem 3 days and 20 days after the pesticide application.

FIG. 4 shows the concentration of chlorantraniliprole absorbed in rice stems collected at different distances from the site of application.

### DETAILED DESCRIPTION OF THE INVENTION

As used herein, the terms “comprises”, “comprising”, “includes”, “including”, “has”, “having” or any other variation thereof, are intended to cover a non-exclusive inclusion. For example, a composition, a mixture, process, method, article, or apparatus that comprises a list of elements is not necessarily limited to only those elements but may include other elements not expressly listed or inherent to such composition, mixture, process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of “a” or “an” are employed to describe elements and components of the invention. This is done merely for convenience and to give a general sense of the invention. This description should be read to include one or at least one and the singular also includes the plural unless it is explicitly specified otherwise.

When a range of values is cited, it should be presumed that the entire range includes the terminal values stated. It also is understood that any numerical range recited herein includes all values from the lower value to the upper value. For example, if a weight ratio range is stated as 1:50, it is intended that values such as 2:40, 10:30, or 1:3, etc., are expressly enumerated in this specification. These are only examples of what is specifically intended, and all possible combinations of numerical values between and including the lowest value and the highest value enumerated are to be considered to be expressly stated in this application.

As used herein, the term “about” refers to plus or minus 10% of the value.

In one aspect, the present disclosure provides herein a formulation comprising a composition comprising: a pesticidal active ingredient; an enhancer, wherein the enhancer comprises a salt of dialkylsulfosuccinate, a salt of lauryl sulfate, a salt of lauryl benzene sulfonate, fatty alcohol derivative, a salt of alkyl naphthyl sulphonate, or a salt of alkylnaphthyl sulphate, or a mixture thereof; a dispersing agent, wherein the dispersing agent comprises polycarboxylate, phenol sulfonic acid condensation, polyoxypropylene-polyoxyethylene block copolymer, or naphthalene sulfonic acid condensation, or a mixture thereof; a binder; and optionally a filler.

In another aspect, the present disclosure provides herein a formulation comprising a composition comprising by weight based on the total weight of the composition: about 0.1% to about 20% of a pesticidal active ingredient; about 0.1% to about 5% of at least one enhancer, wherein the enhancer comprises a salt of dialkylsulfosuccinate, a salt of lauryl sulfate, a salt of lauryl benzene sulfonate, fatty alcohol derivative, a salt of alkyl naphthyl sulphonate, or a salt of alkylnaphthyl sulphate, or a mixture thereof; about 0.1% to about 10% of at least one dispersing agent, wherein the dispersing agent comprises polycarboxylate, phenol sulfonic acid condensation, polyoxypropylene-polyoxyethylene block copolymer, or naphthalene sulfonic acid condensation, or a mixture thereof; about 0.1% to about 20% of at least one binder; and about 0.1% to about 50% of at least one filler.

In another aspect, the present disclosure provides herein a tablet formulation comprising by weight based on the total weight of the composition: about 0.1% to about 20% of a pesticidal active ingredient; about 0.1% to about 5% of at least one enhancer, wherein the enhancer comprises a salt of dialkylsulfosuccinate, a salt of lauryl sulfate, a salt of lauryl benzene sulfonate, fatty alcohol derivative, a salt of alkyl naphthyl sulphonate, or a salt of alkylnaphthyl sulphate, or a mixture thereof; about 0.1% to about 10% of at least one dispersing agent, wherein the dispersing agent comprises polycarboxylate, phenol sulfonic acid condensation, polyoxypropylene-polyoxyethylene block copolymer, or naphthalene sulfonic acid condensation, or a mixture thereof; about 0.1% to about 20% of at least one binder; and about 0.1% to about 50% of at least one filler.

The term “pesticidal active ingredient” as used herein encompasses those selected from the following classes, including mixtures thereof: herbicides, fungicides, bactericides, insecticides, nematocides, acaricides, and growth regulators.

Insecticides useful in the present invention are: insecticides such as abamectin, acephate, acequinocyl, acetamiprid, acrinathrin, acynonapyr, afidopyropen ([(3 S,4R,4aR,6S,6aS,12R,12aS,12b S)-3-[(cyclopropylcarbonyl)oxy]-1,3,4,4a,5,6,6a,12,12a,12b-decahydro-6,12-dihydroxy-4,6a,12b-trimethyl-11-oxo-9-(3-pyridinyl)-2H,11H-naphtho[2,1-b]pyrano[3,4-e]pyran-4-yl]methyl cyclopropanecarboxylate), amidoflumet, amitraz, avermectin, azadirachtin, azinphos methyl, benfuracarb, bensultap, benzpyrimoxan, bifenthrin, kappa-bifenthrin, bifenazate, bistrifluron, borate, broflanilide, buprofezin, cadusafos, carbaryl, carbofuran, cartap, carzol, chlorantraniliprole, chlorfenapyr, chlorfluazuron, chloroprallethrin, chlorpyrifos, chlorpyrifos-e, chlorpyrifos-methyl, chromafenozide, clofentezin, chloroprallethrin, clothianidin, cyantraniliprole, (3-bromo-1-(3-chloro-2-pyridinyl)-N-[4-cyano-2-methyl-6-[(methylamino)carbonyl]phenyl]-1H-pyrazole-5-carboxamide), cyclaniliprole (3-bromo-N-[2-bromo-4-chloro-6-[[(1-cyclopropylethyl)amino]carbonyl]phenyl]-1-(3-chloro-2-pyridinyl)-1H-pyrazole-5-carboxamide), cycloprothrin, cycloxaprid ((5S,8R)-1-[(6-chloro-3-pyridinyl)methyl]-2,3,5,6,7,8-hexahydro-9-nitro-5,8-Epoxy-1H-imidazo[1,2-a]azepine), cyenopyrafen, cyflumetofen, cyfluthrin, beta cyfluthrin, cyhalodiamide, cyhalothrin, gamma-cyhalothrin, lambda-cyhalothrin, cypermethrin, alpha-cypermethrin, zeta-cypermethrin, cyromazine, deltamethrin, diafenthiuron, diazinon, dicloromesotiaz, dieldrin, diflubenzuron, dimefluthrin, dimehypo, dimethoate, dimpropyridaz, dinotefuran, diofenolan, emamectin, emamectin benzoate, endosulfan, esfenvalerate, ethiprole, etofenprox, epsilon-metofluthrin, etoxazole, fenbutatin oxide, fenitrothion, fenothiocarb, fenoxycarb, fenpropathrin, fenvalerate, fipronil, flometoquin (2-ethyl-3,7-dimethyl-6-[4-(trifluoromethoxy)phenoxy]-4-quinolinyl methyl carbonate), flonicamid, fluazaindolizine, flubendiamide, flucythrinate, flufenerim, flufenoxuron, flufenoxystrobin (methyl (αE)-2-[[2-chloro-4-(trifluoromethyl)phenoxy]methyl]-α-(methoxymethylene)benzeneacetate), fluensulfone (5-chloro-2-[(3,4,4-trifluoro-3-buten-1-yl)sulfonyl]thiazole), fluhexafon, fluopyram, flupiprole (1-[2,6-dichloro-4-(trifluoromethyl)phenyl]-5-[(2-methyl-2-propen-1-yl)amino]-4-[(trifluoromethyl)sulfinyl]-1H-pyrazole-3-carbonitrile), flupyradifurone (4-[[(6-chloro-3-pyridinyl)methyl](2,2-difluoroethyl)amino]-2(5H)-furanone), flupyrimin, fluvalinate, tau fluvalinate, fluxametamide, fonophos, formetanate, fosthiazate, gamma-cyhalothrin, halofenozide, heptafluthrin ([2,3,5,6-tetrafluoro-4-(methoxymethyl)phenyl]methyl 2,2-dimethyl-3-[(1Z)-3,3,3-trifluoro-1-propen-1-yl]cyclopropanecarboxylate), hexaflumuron, hexythiazox, hydramethylnon, imidacloprid, indoxacarb, insecticidal soaps, isofenphos, isocycloseram, kappa-tefluthrin, lambda-cyhalothrin, lufenuron, malathion, meperfluthrin ([2,3,5,6-tetrafluoro-4-(methoxymethyl)phenyl]methyl (1R, 3 S)-3-(2,2-dichloroethenyl)-2,2-dimethylcyclopropanecarboxylate), metaflumizone, metaldehyde, methamidophos, methidathion, methiocarb, methomyl, methoprene, methoxychlor, metofluthrin, methoxyfenozide, epsilon-metofluthrin, epsilon-momfluorothrin, monocrotophos, monofluorothrin ([2,3,5,6-tetrafluoro-4-(methoxymethyl)phenyl]methyl 3-(2-cyano-1-propen-1-yl)-2,2-dimethylcyclopropanecarboxylate), nicotine, nitenpyram, nithiazine, novaluron, noviflumuron, oxamyl, oxazosulfyl, parathion, parathion methyl, permethrin, phorate, phosalone, phosmet, phosphamidon, pirimicarb, profenofos, profluthrin, propargite, protrifenbute, pyflubumide (1,3,5-trimethyl-N-(2-methyl-1-oxopropyl)-N-[3-(2-methylpropyl)-4-[2,2,2-trifluoro-1-methoxy-1-(trifluoromethyl)ethyl]phenyl]-1H-pyrazole-4-carboxamide), pymetrozine, pyrafluprole, pyrethrin, pyridaben, pyridalyl, pyrifluquinazon, pyriminostrobin (methyl (αE)-2-[[[2-[(2,4-dichlorophenyl)amino]-6-(trifluoromethyl)-4-pyrimidinyl]oxy]methyl]-α-(methoxymethylene)benzeneacetate), pyriprole, pyriproxyfen, rotenone, ryanodine, silafluofen, spinetoram, spinosad, spirodiclofen, spiromesifen, spiropidion, spirotetramat, sulprofos, sulfoxaflor (N-[methyloxido[1-[6-(trifluoromethyl)-3-pyridinyl]ethyl]-λ4-sulfanylidene]cyanamide), tebufenozide, tebufenpyrad, teflubenzuron, tefluthrin, kappa-tefluthrin, terbufos, tetrachlorantraniliprole, tetrachlorvinphos, tetramethrin, tetramethylfluthrin ([2,3,5,6-tetrafluoro-4-(methoxymethyl)phenyl]methyl 2,2,3,3-tetramethylcyclopropanecarboxylate), tetraniliprole, thiacloprid, thiamethoxam, thiodicarb, thiosultap-sodium, tioxazafen (3-phenyl-5-(2-thienyl)-1,2,4-oxadiazole), tolfenpyrad, tralomethrin, triazamate, trichlorfon, triflumezopyrim (2,4-dioxo-1-(5-pyrimidinylmethyl)-3-[3-(trifluoromethyl)phenyl]-2H-pyrido[1,2-a]pyrimidinium inner salt), triflumuron, tyclopyrazoflor, zeta-cypermethrin, Bacillus thuringiensis delta-endotoxins, entomopathogenic bacteria, entomopathogenic viruses or entomopathogenic fungi.

Herbicides useful in the present invention are: herbicides selected from (b1) photosystem II inhibitors, (b2) acetohydroxy acid synthase (AHAS) inhibitors, (b3) acetyl-CoA carboxylase (ACCase) inhibitors, (b4) auxin mimics, (b5) 5-enol-pyruvylshikimate-3-phosphate (EPSP) synthase inhibitors, (b6) photosystem I electron diverters, (b7) protoporphyrinogen oxidase (PPO) inhibitors, (b8) glutamine synthetase (GS) inhibitors, (b9) very long chain fatty acid (VLCFA) elongase inhibitors, (b10) auxin transport inhibitors, (b11) phytoene desaturase (PDS) inhibitors, (b12) 4-hydroxyphenyl pyruvate dioxygenase (HPPD) inhibitors, (b13) homogentisate solenesyltransererase (HST) inhibitors, (b14) cellulose biosynthesis inhibitors, (b15) other herbicides including mitotic disruptors, organic arsenicals, asulam, bromobutide, cinmethylin, cumyluron, dazomet, difenzoquat, dymron, etobenzanid, flurenol, fosamine, fosamine ammonium, hydantocidin, metam, methyldymron, oleic acid, oxaziclomefone, pelargonic acid and pyributicarb, and (b16) herbicide safeners; and salts of compounds of (b 1) through (b16).

“Photosystem II inhibitors (b1)” are chemical compounds that bind to the D1 protein at the QB binding niche and thus block electron transport from QA to QB in the chloroplast thylakoid membranes. The electrons blocked from passing through photosystem II are transferred through a series of reactions to form toxic compounds that disrupt cell membranes and cause chloroplast swelling, membrane leakage, and ultimately cellular destruction. The QB binding niche has three different binding sites: binding site A binds the triazines such as atrazine, triazinones such as hexazinone, and uracils such as bromacil, binding site B binds the phenylureas such as diuron, and binding site C binds benzothiadiazoles such as bentazon, nitriles such as bromoxynil and phenyl pyridazines such as pyridate. Examples of photosystem II inhibitors include ametryn, amicarbazone, atrazine, bentazon, bromacil, bromofenoxim, bromoxynil, chlorbromuron, chloridazon, chlorotoluron, chloroxuron, cumyluron, cyanazine, daimuron, desmedipham, desmetryn, dimefuron, dimethametryn, diuron, ethidimuron, fenuron, fluometuron, hexazinone, ioxynil, isoproturon, isouron, lenacil, linuron, metamitron, methabenzthiazuron, metobromuron, metoxuron, metribuzin, monolinuron, neburon, pentanochlor, phenmedipham, prometon, prometryn, propanil, propazine, pyridafol, pyridate, siduron, simazine, simetryn, tebuthiuron, terbacil, terbumeton, terbuthylazine, terbutryn and trietazine.

“AHAS inhibitors (b2)” are chemical compounds that inhibit acetohydroxy acid synthase (AHAS), also known as acetolactate synthase (ALS), and thus kill plants by inhibiting the production of the branched chain aliphatic amino acids such as valine, leucine and isoleucine, which are required for protein synthesis and cell growth. Examples of AHAS inhibitors include amidosulfuron, azimsulfuron, bensulfuron methyl, bispyribac sodium, cloransulam methyl, chlorimuron ethyl, chlorsulfuron, cinosulfuron, cyclosulfamuron, diclosulam, ethametsulfuron methyl, ethoxysulfuron, flazasulfuron, florasulam, flucarbazone sodium, flumetsulam, flupyrsulfuron methyl, flupyrsulfuron-sodium, foramsulfuron, halosulfuron methyl, imazamethabenz methyl, imazamox, imazapic, imazapyr, imazaquin, imazethapyr, imazosulfuron, iodosulfuron methyl (including sodium salt), iofensulfuron (2-iodo-N-[[(4-methoxy-6-methyl-1,3,5-triazin-2-yl)amino]carbonylThenzenesulfonamide), mesosulfuron methyl, metazosulfuron (3-chloro-4-(5,6-dihydro-5-methyl-1,4,2-dioxazin-3-yl)-N-[[(4,6-dimethoxy-2-pyrimidinyl)amino] carbonyl]-1-methyl-1H-pyrazole-5-sulfonamide), metosulam, metsulfuron methyl, nicosulfuron, oxasulfuron, penoxsulam, primisulfuron methyl, propoxycarbazone sodium, propyrisulfuron (2-chloro-N-[[(4,6-dimethoxy-2-pyrimidinyl)amino]carbonyl]-6-propylimidazo[1,2-b]pyridazine-3-sulfonamide), prosulfuron, pyrazosulfuron ethyl, pyribenzoxim, pyriftalid, pyriminobac methyl, pyrithiobac sodium, rimsulfuron, sulfometuron methyl, sulfosulfuron, thiencarbazone, thifensulfuron methyl, triafamone (N-[2-[(4,6-dimethoxy-1,3,5-triazin-2-yl)carbonyl]-6-fluorophenyl]-1,1-difluoro-N-methylmethanesulfonamide), triasulfuron, tribenuron methyl, trifloxysulfuron (including sodium salt), triflusulfuron methyl and tritosulfuron.

“ACCase inhibitors (b3)” are chemical compounds that inhibit the acetyl CoA carboxylase enzyme, which is responsible for catalyzing an early step in lipid and fatty acid synthesis in plants. Lipids are essential components of cell membranes, and without them, new cells cannot be produced. The inhibition of acetyl CoA carboxylase and the subsequent lack of lipid production leads to losses in cell membrane integrity, especially in regions of active growth such as meristems. Eventually shoot and rhizome growth ceases, and shoot meristems and rhizome buds begin to die back. Examples of ACCase inhibitors include alloxydim, butroxydim, clethodim, clodinafop, cycloxydim, cyhalofop, diclofop, fenoxaprop, fluazifop, haloxyfop, pinoxaden, profoxydim, propaquizafop, quizalofop, sethoxydim, tepraloxydim and tralkoxydim, including resolved forms such as fenoxaprop P, fluazifop P, haloxyfop P and quizalofop P and ester forms such as clodinafop propargyl, cyhalofop butyl, diclofop methyl and fenoxaprop P ethyl.

Auxin is a plant hormone that regulates growth in many plant tissues. “Auxin mimics (b4)” are chemical compounds mimicking the plant growth hormone auxin, thus causing uncontrolled and disorganized growth leading to plant death in susceptible species. Examples of auxin mimics include aminocyclopyrachlor (6-amino-5-chloro-2-cyclopropyl-4-pyrimidinecarboxylic acid) and its methyl and ethyl esters and its sodium and potassium salts, aminopyralid, benazolin ethyl, chloramben, clacyfos, clomeprop, clopyralid, dicamba, 2,4 D, 2,4 DB, dichlorprop, fluroxypyr, halauxifen (4-amino-3-chloro-6-(4-chloro-2-fluoro-3-methoxyphenyl)-2-pyridinecarboxylic acid), halauxifen-methyl (methyl 4-amino-3-chloro-6-(4-chloro-2-fluoro-3-methoxyphenyl)-2-pyridinecarboxylate), MCPA, MCPB, mecoprop, picloram, quinclorac, quinmerac, 2,3,6 TBA, triclopyr, and methyl 4-amino-3-chloro-6-(4-chloro-2-fluoro-3-methoxyphenyl)-5-fluoro-2-pyridinecarboxylate.

“EPSP synthase inhibitors (b5)” are chemical compounds that inhibit the enzyme, 5-enol pyruvylshikimate-3-phosphate synthase, which is involved in the synthesis of aromatic amino acids such as tyrosine, tryptophan and phenylalanine. EPSP inhibitor herbicides are readily absorbed through plant foliage and translocated in the phloem to the growing points. Glyphosate is a relatively nonselective postemergence herbicide that belongs to this group. Glyphosate includes esters and salts such as ammonium, isopropylammonium, potassium, sodium (including sesquisodium) and trimesium (alternatively named sulfosate).

“Photosystem I electron diverters (b6)” are chemical compounds that accept electrons from Photosystem I, and after several cycles, generate hydroxyl radicals. These radicals are extremely reactive and readily destroy unsaturated lipids, including membrane fatty acids and chlorophyll. This destroys cell membrane integrity, so that cells and organelles “leak”, leading to rapid leaf wilting and desiccation, and eventually to plant death. Examples of this second type of photosynthesis inhibitor include diquat and paraquat.

“PPO inhibitors (b7)” are chemical compounds that inhibit the enzyme protoporphyrinogen oxidase, quickly resulting in formation of highly reactive compounds in plants that rupture cell membranes, causing cell fluids to leak out. Examples of PPO inhibitors include acifluorfen sodium, azafenidin, benzfendizone, bifenox, butafenacil, carfentrazone, carfentrazone ethyl, chlomethoxyfen, cinidon ethyl, fluazolate, flufenpyr ethyl, flumiclorac pentyl, flumioxazin, fluoroglycofen ethyl, fluthiacet methyl, fomesafen, halosafen, lactofen, oxadiargyl, oxadiazon, oxyfluorfen, pentoxazone, profluazol, pyraclonil, pyraflufen ethyl, saflufenacil, sulfentrazone, thidiazimin, trifludimoxazin (dihydro-1,5-dimehyl-6-thioxo-3-[2,2,7-trifluoro-3,4-dihydro-3-oxo-4-(2-propyn-1-yl)-2H-1,4-benzoxazin-6-yl]-1,3,5-triazine-2,4(1H,3H)-dione) and tiafenacil (methyl N-[2-[[2-chloro-5-[3,6-dihydro-3-methyl-2,6-dioxo-4-(trifluoromethyl)-1(2H)-pyrimidinyl]-4-fluorophenyl]thio]-1-oxopropyl]-β-alaninate).

“GS inhibitors (b8)” are chemical compounds that inhibit the activity of the glutamine synthetase enzyme, which plants use to convert ammonia into glutamine. Consequently, ammonia accumulates and glutamine levels decrease. Plant damage probably occurs due to the combined effects of ammonia toxicity and deficiency of amino acids required for other metabolic processes. The GS inhibitors include glufosinate and its esters and salts such as glufosinate ammonium and other phosphinothricin derivatives, glufosinate P ((2S)-2-amino-4-(hydroxymethylphosphinyl)butanoic acid) and bilanaphos.

“VLCFA elongase inhibitors (b9)” are herbicides having a wide variety of chemical structures, which inhibit the elongase. Elongase is one of the enzymes located in or near chloroplasts which are involved in biosynthesis of VLCFAs. In plants, very long chain fatty acids are the main constituents of hydrophobic polymers that prevent desiccation at the leaf surface and provide stability to pollen grains. Such herbicides include acetochlor, alachlor, anilofos, butachlor, cafenstrole, dimethachlor, dimethenamid, diphenamid, fenoxasulfone (3-[[(2,5-dichloro-4-ethoxyphenyl)methyl]sulfonyl]-4,5-dihydro-5,5-dimethylisoxazole), fentrazamide, flufenacet, indanofan, mefenacet, metazachlor, metolachlor, naproanilide, napropamide, napropamide-M ((2R)—N,N-diethyl-2-(1-naphthalenyloxy)propanamide), pethoxamid, piperophos, pretilachlor, propachlor, propisochlor, pyroxasulfone, and thenylchlor, including resolved forms such as S metolachlor and chloroacetamides and oxyacetamides.

“Auxin transport inhibitors (b10)” are chemical substances that inhibit auxin transport in plants, such as by binding with an auxin carrier protein. Examples of auxin transport inhibitors include diflufenzopyr, naptalam (also known as N-(1-naphthyl)-phthalamic acid and 2-[(1-naphthalenylamino)carbonyl]benzoic acid).

“PDS inhibitors (b11)” are chemical compounds that inhibit carotenoid biosynthesis pathway at the phytoene desaturase step. Examples of PDS inhibitors include m-beflubutamid, beflubutamid, diflufenican, fluridone, flurochloridone, flurtamone norflurzon and picolinafen.

“HPPD inhibitors (b12)” are chemical substances that inhibit the biosynthesis of synthesis of 4 hydroxy¬phenyl-pyruvate dioxygenase. Examples of HPPD inhibitors include benzobicyclon, benzofenap, bicyclopyrone (4-hydroxy-3-[[2-[(2-methoxyethoxy)methyl]-6-(trifluoromethyl)-3-pyridinyl]carbonyl]bicyclo[3.2.1]oct-3-en-2-one), fenquinotrione (2-[[8-chloro-3,4-dihydro-4-(4-methoxyphenyl)-3-oxo-2-quinoxalinyl]carbonyl]-1,3-cyclohexanedione), isoxachlortole, isoxaflutole, mesotrione, pyrasulfotole, pyrazolynate, pyrazoxyfen, sulcotrione, tefuryltrione, tembotrione, tolpyralate (1-[[1-ethyl-4-[3-(2-methoxyethoxy)-2-methyl-4-(methylsulfonyl)benzoyl]-1H-pyrazol-5-yl]oxy]ethyl methyl carbonate), topramezone, 5-chloro-3-[(2-hydroxy-6-oxo-1-cyclohexen-1-yl)carbonyl]-1-(4-methoxyphenyl)-2(1H)-quinoxalinone, 4-(2,6-diethyl-4-methylphenyl)-5-hydroxy-2,6-dimethyl-3(2H)-pyridazinone, 4-(4-fluorophenyl)-6-[(2-hydroxy-6-oxo-1-cyclohexen-1-yl)carbonyl]-2-methyl-1,2,4-triazine-3,5(2H,4H)-dione, 5-[(2-hydroxy-6-oxo-1-cyclohexen-1-yl)carbonyl]-2-(3-methoxyphenyl)-3-(3-methoxypropyl)-4(3H)-pyrimidinone, 2-methyl-N-(4-methyl-1,2,5-oxadiazol-3-yl)-3-(methylsulfinyl)-4-(trifluoromethyl)benzamide and 2-methyl-3-(methylsulfonyl)-N-(1-methyl-1H-tetrazol-5-yl)-4-(trifluoromethyl)benzamide.

“HST inhibitors (bi3)” disrupt a plant's ability to convert homogentisate to 2-methyl-6-solanyl-1,4-benzoquinone, thereby disrupting carotenoid biosynthesis. Examples of HST inhibitors include haloxydine, pyriclor, 3-(2-chloro-3,6-difluorophenyl)-4-hydroxy-1-methyl-1,5-naphthyridin-2(1H)-one, 7-(3,5-dichloro-4-pyridinyl)-5-(2,2-difluoroethyl)-8-hydroxypyrido[2,3-b]pyrazin-6(5H)-one and 4-(2,6-diethyl-4-methylphenyl)-5-hydroxy-2,6-dimethyl-3(2H)-pyridazinone.

HST inhibitors also include compounds of Formulae A and B.

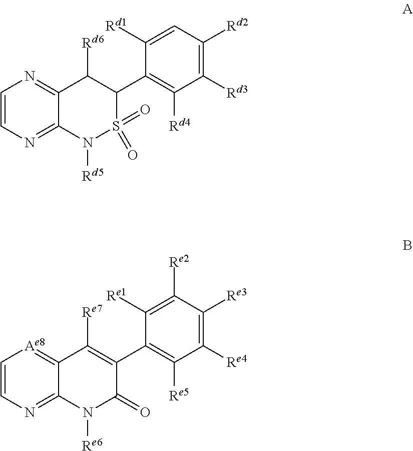

wherein R^{d1} is H, Cl or CF₃; R^{d2} is H, Cl or Br; R^{d3} is H or Cl; R^{d4} is H, Cl or CF₃; R^{d5} is CH₃, CH₂CH₃ or CH₂CHF₂; and R^{d6} is OH, or —OC(═O)-i-Pr; and Rel is H, F, Cl, CH₃ or CH₂CH₃; R^{e2} is H or CF₃; R^{e3} is H, CH₃ or CH₂CH₃; R^{e4} is H, F or Br; R^{e5} is Cl, CH₃, CF₃, OCF₃ or CH₂CH₃; R^{e6} is H, CH₃, CH₂CHF₂ or C≡CH; R^{e7} is OH, —OC(═O)Et, —OC(═O)-i-Pr or —OC(═O)-t-Bu; and A^{e8} is N or CH.

“Cellulose biosynthesis inhibitors (b14)” inhibit the biosynthesis of cellulose in certain plants. They are most effective when applied preemergence or early postemergence on young or rapidly growing plants. Examples of cellulose biosynthesis inhibitors include chlorthiamid, dichlobenil, flupoxam, indaziflam (N2-[(1R,2S)-2,3-dihydro-2,6-dimethyl-1H-inden-1-yl]-6-(1-fluoroethyl)-1,3,5-triazine-2,4-diamine), isoxaben and triaziflam.

“Other herbicides (b15)” include herbicides that act through a variety of different modes of action such as mitotic disruptors (e.g., flamprop M methyl and flamprop M isopropyl), organic arsenicals (e.g., DSMA, and MSMA), 7,8-dihydropteroate synthase inhibitors, chloroplast isoprenoid synthesis inhibitors and cell wall biosynthesis inhibitors. Other herbicides include those herbicides having unknown modes of action or do not fall into a specific category listed in (b1) through (b14) or act through a combination of modes of action listed above. Examples of other herbicides include aclonifen, asulam, amitrole, bixlozone, bromobutide, cinmethylin, clomazone, cumyluron, cyclopyrimorate (6-chloro-3-(2-cyclopropyl-6-methylphenoxy)-4-pyridazinyl 4-morpholinecarboxylate), daimuron, difenzoquat, etobenzanid, fluometuron, flurenol, fosamine, fosamine ammonium, dazomet, dymron, ipfencarbazone (1-(2,4-dichlorophenyl)-N-(2,4-difluorophenyl)-1,5-dihydro-N-(1-methylethyl)-5-oxo-4H-1,2,4-triazole-4-carboxamide), metam, methyldymron, oleic acid, oxaziclomefone, pelargonic acid, pyributicarb and 5-[[(2,6-difluorophenyl)methoxy]methyl]-4,5-dihydro-5-methyl-3-(3-methyl-2-thienyl)isoxazole and tetflupyrolimet.

Fungicides useful in the present invention are: fungicides such as acibenzolar-S-methyl, aldimorph, ametoctradin, aminopyrifen, amisulbrom, anilazine, azaconazole, azoxystrobin, benalaxyl (including benalaxyl-M), benodanil, benomyl, benthiavalicarb (including benthiavalicarb-isopropyl), benzovindiflupyr, bethoxazin, binapacryl, biphenyl, bitertanol, bixafen, blasticidin-S, boscalid, bromuconazole, bupirimate, buthiobate, carboxin, carpropamid, captafol, captan, carbendazim, chloroneb, chlorothalonil, chlozolinate, copper hydroxide, copper oxychloride, copper sulfate, coumoxystrobin, cyazofamid, cyflufenamid, cymoxanil, cyproconazole, cyprodinil, dichlobentiazox, dichlofluanid, diclocymet, diclomezine, dicloran, diethofencarb, difenoconazole, diflumetorim, dimethirimol, dimethomorph, dimoxystrobin, diniconazole (including diniconazole M), dinocap, dipymetitrone, dithianon, dithiolanes, dodemorph, dodine, econazole, etaconazole, edifenphos, enoxastrobin (also known as enestroburin), epoxiconazole, ethaboxam, ethirimol, etridiazole, famoxadone, fenamidone, fenaminstrobin, fenarimol, fenbuconazole, fenfuram, fenhexamide, fenoxanil, fenpiclonil, fenpicoxamid, fenpropidin, fenpropimorph, fenpyrazamine, fentin acetate, fentin hydroxide, ferbam, ferimzone, flometoquin, florylpicoxamid, fluopimomide, fluazinam, fludioxonil, flufenoxystrobin, fluindapyr, flumorph, fluopicolide, fluopyram, fluoxapiprolin, fluoxastrobin, fluquinconazole, flusilazole, flusulfamide, flutianil, flutolanil, flutriafol, fluxapyroxad, folpet, fthalide (also known as phthalide), fuberidazole, furalaxyl, furametpyr, hexaconazole, hymexazole, guazatine, imazalil, imibenconazole, iminoctadine albesilate, iminoctadine triacetate, inpyrfluxam, iodicarb, ipconazole, ipfentrifluconazole, ipflufenoquin, isofetamid, iprobenfos, iprodione, iprovalicarb, isoflucypram, isoprothiolane, isopyrazam, isotianil, kasugamycin, kresoxim-methyl, lancotrione, mancozeb, mandipropamid, mandestrobin, maneb, mapanipyrin, mefentrifluconazole, mepronil, meptyldinocap, metalaxyl (including metalaxyl-M/mefenoxam), metconazole, methasulfocarb, metiram, metominostrobin, metyltetraprole, metrafenone, myclobutanil, naftitine, neo-asozin (ferric methanearsonate), nuarimol, octhilinone, ofurace, orysastrobin, oxadixyl, oxathiapiprolin, oxolinic acid, oxpoconazole, oxycarboxin, oxytetracycline, penconazole, pencycuron, penflufen, penthiopyrad, perfurazoate, phosphorous acid (including salts thereof, e.g., fosetyl-aluminm), picoxystrobin, piperalin, polyoxin, probenazole, prochloraz, procymidone, propamocarb, propiconazole, propineb, proquinazid, prothiocarb, prothioconazole, pydiflumetofen (Adepidyn®), pyraclostrobin, pyrametostrobin, pyrapropoyne, pyraoxystrobin, pyraziflumid, pyrazophos, pyribencarb, pyributacarb, pyridachlometyl, pyrifenox, pyriofenone, perisoxazole, pyrimethanil, pyrifenox, pyrrolnitrin, pyroquilon, quinconazole, quinmethionate, quinofumelin, quinoxyfen, quintozene, silthiofam, sedaxane, simeconazole, spiroxamine, streptomycin, sulfur, tebuconazole, tebufloquin, teclofthalam, tecloftalam, tecnazene, terbinafine, tetraconazole, thiabendazole, thifluzamide, thiophanate, thiophanate-methyl, thiram, tiadinil, tolclofos-methyl, tolprocarb, tolyfluanid, triadimefon, triadimenol, triarimol, triazoxide, tribasic copper sulfate, triclopyricarb, tridemorph, trifloxystrobin, triflumizole, trimoprhamide tricyclazole, trifloxystrobin, triforine, triticonazole, uniconazole, validamycin, valifenalate (also known as valifenal), vinclozolin, zineb, ziram, zoxamide and 1-[4-[4-[5-(2,6-difluorophenyl)-4,5-dihydro-3-isoxazolyl]-2-thiazolyl]-1-piperidinyl]-2-[5-methyl-3-(trifluoromethyl)-1H-pyrazol-1-yl]ethanone; nematocides such as fluopyram, spirotetramat, thiodicarb, fosthiazate, abamectin, iprodione, fluensulfone, dimethyl disulfide, tioxazafen, 1,3-dichloropropene (1,3-D), metam (sodium and potassium), dazomet, chloropicrin, fenamiphos, ethoprophos, cadusaphos, terbufos, imicyafos, oxamyl, carbofuran, tioxazafen, Bacillus firmus and Pasteuria nishizawae; bactericides such as streptomycin; acaricides such as amitraz, chinomethionat, chlorobenzilate, cyhexatin, dicofol, dienochlor, etoxazole, fenazaquin, fenbutatin oxide, fenpropathrin, fenpyroximate, hexythiazox, propargite, pyridaben and tebufenpyrad.

In certain embodiments, the pesticidal active ingredient is an insecticide.

The term “insecticide” as used herein encompasses all agents that have controlling or modifying effect on insect growth, including but not limited to, killing, injury, retarding, stunting of growth, disorientation, inhibition of reproduction, and the like.

In certain embodiments, the pesticidal active ingredient is a diamide, neonicotinoid, or nereistoxin analogue insecticide, or a mixture thereof. In some embodiments, the pesticidal active ingredient is chlorantraniliprole, cyantraniliprole, tetraniliprole, cyclaniliprole, cyhalodiamide, tetra-chlorantraniliprole, bromoantraniliprole, dichlorantraniliprole, thiamethoxam, clothianidin, thiacloprid, monosultap, or bisultap, or a mixture thereof.

In certain embodiments, the pesticidal active ingredient is an anthranilamide.

The term “anthranilamide” as used herein refers to a class of carboxamide arthropodicides having insecticide activity against numerous economically important agronomic and nonagronomic invertebrate pests. Anthranilamides affect calcium homeostasis by binding to ryanodine receptors, a class of intracellular calcium channels. Upon its binding, the calcium channels are open and release calcium ions into the cytoplasm. Depletion of calcium ion stores results in insect paralysis and death. Anthranilamides are characterized chemically by molecular structures comprising vicinal carboxamide substituents bonded to the carbon atoms of an aryl ring, typically phenyl, wherein one carboxamide moiety is bonded through the carbonyl carbon and the other carboxamide moiety is bonded through the nitrogen atom.

In some embodiments, the anthranilamide is selected from the compound of Formula I, N-oxides and salts thereof.

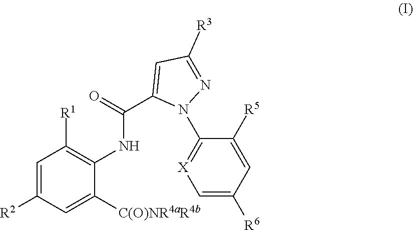

Wherein X is N, CF, CCl, CBr or Cl; R¹ is H, CH₃, Cl, Br or F; R² is H, F, Cl, Br or —CN; R³ is F, Cl, Br, C₁-C₄ haloalkyl or C₁-C₄ haloalkoxy; R^{4a} is H, C₁-C₄ alkyl, cyclopropylmethyl or 1-cyclopropylethyl; R^{4b} is H or CH₃; R⁵ is H, F, Cl or Br; and R⁶ is H, F, Cl or Br.

In some embodiments, the anthranilamide is chlorantraniliprole, cyantraniliprole, tetraniliprole, cyclaniliprole, cyhalodiamide, bromoantraniliprole, dichlorantraniliprole, or tetra-chlorantraniliprole, or a mixture thereof. Other anthranilamides and methods for their preparation are described in detail in U.S. Pat. Nos. 6,747,047, WO 2003/015519, WO 2004/067528, WO2006/062978 and WO2008/069990, which are incorporated herein by way of reference.

In some embodiments, the anthranilamide is chlorantraniliprole, or cyantraniliprole, or a mixture thereof.

Chlorantraniliprole is an insecticide of the anthranilic diamide class and has a chemical name 5-bromo-N-[4-chloro-2-methyl-6-(methylcarbamoyl)phenyl]-2-(3-chloropyridin-2-yl)pyrazole-3-carboxamide, and trademarked by FMC Corporation as Rynaxypyr®. Chlorantraniliprole is a ryanodine receptor agonist and is used to protect a wide variety of crops, including corn, cotton, grapes, rice and potatoes. Insects exposed to chlorantraniliprole exhibit general lethargy and muscle paralysis followed ultimately by death. Findings indicate that chlorantraniliprole exhibits excellent differential selectivity for insect ryanodine receptors over mammalian ryanodine receptors. This selectivity is likely a major contributing factor to the mammalian safety observed with chlorantraniliprole.

Cyantraniliprole has a chemical name 3-bromo-1-(3-chloro-2-pyridinyl)-N-[4-cyano-2-methyl-6-[(methylamino)carbonyl]phenyl]-1H-pyrazole-5-carboxamide, and trademarked by FMC Corporation as Cyazypyr®. Cyantraniliprole is a carboxamide that is chlorantraniliprole in which the chlorine atom attached to the phenyl ring has been replaced by a cyano group. Cyantraniliprole can be used as an insecticide for the control of whitefly, thrips, aphids, fruitflies, and fruit worms in crops such as onions, potatoes and tomatoes. It has a role as a ryanodine receptor agonist.

In certain embodiments, the composition provided herein comprises an anthranilamide at about 1% to about 10%, about 1% to about 8%, about 1% to about 7%, about 1% to about 6%, about 1% to about 5.5%, about 1%, about 2.5% or about 5% of the composition by weight. In certain embodiments, the anthranilamide is chlorantraniliprole.

Because the efficacy and chemical stability of the active ingredient and physical stability of the formulated composition may be affected by inert ingredients in the formulation, suitable inert ingredients should not cause decomposition of the active ingredient, substantially diminish its activity on application, or cause appreciable precipitation or crystal formation upon long-term storage. Furthermore, inert ingredients should be nonphytotoxic and environmentally safe. In certain formulations inert ingredients can even enhance the biological performance of the active ingredient by facilitating penetration or uptake into the plant or arthropod pest or by increasing resistance to wash-off.

In certain embodiments, the enhancer comprises sodium dialkylsulfosuccinate, sodium lauryl sulfate, sodium lauryl benzene sulfonate, fatty alcohol derivative, sodium alkyl naphthyl sulphonate, diocyl sodium sulfosuccinate, or alkylnaphthyl sodium sulphate, or a mixture thereof.

In certain embodiments, the enhancer comprises Geropon® SDS, Aerosol® MA-80I, Aerosol® OT series, MULTIWET™ MO-85P, MORWET® EFW, BEROL™ 790A, RHODACAL® DS 10, STEPWET® DF-90, Tergitol™ W-610, GEROPON® L WET F, GEROPON® L WET P, Terwet® 1004, Terwet® 1010, PETRO® AA, MORWET® IP, SUPRAGIL® WP, or SURFOM® HRB, or a mixture thereof.

In certain embodiments, the composition provided herein comprises, by total weight, about 0.1% to about 5% of at least one enhancer comprising sodium dialkylsulfosuccinate.

The term “enhancer comprising sodium dialkylsulfosuccinate” as used herein refers to any enhancer containing sodium dialkylsulfosuccinate and optionally one or more other substances, regardless whether sodium dialkylsulfosuccinate is the major component of the enhancer, as long as the enhancer can facilitate effective absorption of the active ingredient by the crops or pasture to a level that is effective at controlling pest. In certain embodiments, sodium dialkylsulfosuccinate is the major component of the enhancer. In certain embodiments, the enhancer comprises, by weight, more than about 50%, 55%, 60%, 65%, 70%, 75%, 80%, 85%, 90%, 95% or 98% of sodium dialkylsulfosuccinate. In certain embodiments, the enhancer is in solid form after mixing with other components of the composition. In certain embodiments, the enhancer is in solid form before mixing with any components of the composition.

Suitable enhancers comprising sodium dialkylsulfosuccinate are known, and include but are not limited to Geropon® SDS, Aerosol® MA-80I, Aerosol® OT series, MULTIWET™ MO-85P, and MORWET® EFW.

In certain embodiments, the enhancer is Geropon® SDS. Geropon® SDS is a low use rate, high performance wetting agent for dry formulations.

In certain embodiments, the enhancer is Aerosol® OT-B or Aerosol® OT-75. Aerosol® OT-B and Aerosol® OT-75 are multipurpose anionic surfactants, such as a wetting agent, emulsifier, antistatic/softening agent that can be utilized to reduce surface tension and to increase absorbency and penetration and provides very quick migration to interface.

In certain embodiments, the enhancer is about 0.1% to about 4%, about 0.1% to about 3%, about 0.1% to about 2%, about 0.2% to about 2%, about 0.3% to about 2%, about 0.3% to about 1.8%, about 0.3% to about 1.5%, about 0.3% to about 1.2%, about 0.3% to about 1%, about 0.5% to about 1%, about 0.6% to about 1%, about 0.7% to about 1%, or about 0.8% of the composition by weight.

In certain embodiments, the dispersing agent comprises Geropon® T/36, Geropon® TA-72, Geropon® SC-213, Geropon® Ultrasperse, Duramax® D-205, Duramax® D-305, Duramax® D-518, Tersperse® 2500, Tersperse® 2700, Atlox Metasperse™ 5505, Tamol™ 731 SD, Tamol™ DN, YUS-TXC, Pluronic® PE 10400, MORWE™ D-360, MORWE™ D-110, Morwet® D-425, Tamol™ FB P1, or Tamol™ NN8906.

In certain embodiments, the composition disclosed herein comprises, by total weight, about 0.1% to about 10% of at least one dispersing agent comprising polycarboxylate.

The term “dispersing agent comprising polycarboxylate” as used herein refers to any dispersing agent containing polycarboxylate and optionally one or more other substances, regardless whether polycarboxylate is the major component of the dispersing agent, as long as the dispersing agent can facilitate the diffusion and evenly distribution of the active ingredient in the liquid body. In certain embodiments, polycarboxylate is the major component of the dispersing agent. In certain embodiments, the dispersing agent comprises, by weight, more than about 50%, 55%, 60%, 65%, 70%, 75%, 80%, 85%, 90%, 95% or 98% of polycarboxylate. In certain embodiments, the dispersing agent is in solid form after mixing with other components of the composition. In certain embodiments, the dispersing agent is in solid form before mixing with any components of the composition.

The dispersing agent as used herein can facilitate the diffusion and evenly distribution of the active ingredient in the liquid body, such as cold, hard water (e.g., containing calcium carbonate greater than about 300 ppm, to which the composition is applied, in particularly, when the composition is scattered unevenly).

Suitable dispersing agents comprising polycarboxylate are known, and include but are not limited to Geropon® T/36, Geropon® TA-72, Geropon® SC-213, Geropon® Ultrasperse, Duramax® D-205, Duramax® D-305, Duramax® D-518, Tersperse® 2500, Tersperse® 2700, Atlox Metasperse™ 550S, and Tamol™ 731 SD.

In certain embodiments, the dispersing agent is Tersperse® 2700. Tersperse® 2700 is an acid resin copolymer based dispersing agent (surfactant) developed primarily for use in water dispersible granule formulations.

In certain embodiments, the dispersing agent is Geropon® T/36. Geropon® T/36 is a multipurpose sodium polycarboxylate, very high performance dispersing, compatibility, chelating agent.

In certain embodiments, the dispersing agent is Duramax® D-205.

In certain embodiments, the dispersing agent is about 0.5% to about 10%, about 0.5% to about 8%, about 0.5% to about 7%, about 0.5% to about 6%, about 0.5% to about 5%, about 0.8% to about 5%, about 1% to about 5%, about 1.2% to about 5%, about 1.5% to about 5%, about 1.7% to about 5%, about 2% to about 5%, about 2% to about 4.5%, about 2% to about 4%, about 2% to about 3.5%, about 2% to about 3%, about 2.2% to about 2.8%, about 2.4% to about 2.6%, or about 2.5% of the composition by weight.

In certain embodiments, the enhancer is Geropon® SDS, and the dispersing agent is Tersperse® 2700. In certain embodiments, the enhancer is Aerosol® OT-B, and the dispersing agent is Duramax® D-205. In certain embodiments, the enhancer is Aerosol® OT-75, and the dispersing agent is Geropon® T/36.

A preferred range of enhancer and dispersant agent can improve the efficacy of chlorantraniliprole-containing tablet composition in terms of diffusivity or penetration. In certain embodiments, the ratio between the enhancer and the dispersing agent may be in the range of about 1:1-1:5, 1:1-1:4, 1:2-1:4 or 1:3-1:4 by weight. In certain embodiments, the ratio is about 8:25 by weight. In certain embodiments, the ratio is about 1:3 by weight.

In certain embodiments, the composition provided herein further comprises about 0.1% to about 40% of at least one acid; and about 0.1% to about 40% of at least one alkali.

The acid and the alkali as used herein generally act together to generate gas on contact with water that facilitates disintegration of the composition and the diffusion of the active ingredient. In certain embodiments, the composition includes a solid acid which is capable of reacting with the carbonate component of the composition to liberate carbon dioxide. The acid can be a water-soluble acidic substance being especially polybasic organic acids, such as succinic acid, D, L-tartaric acid, L-tartaric acid, tartaric acid, alkali metal acid sulfates, lactic acid, adipic acid, citric acid, alkali metal acid citrates, alkali metal acid phosphates, alkali metal acid phthalates and p-toluenesulfonic acid, malic acid, maleic acid, malonic acid and oxalic acid, etc. In certain embodiments, the acid is D, L-tartaric acid.

In certain embodiments, the composition provided herein comprises acid at about 0.5% to about 25%, about 1% to about 25%, about 5% to about 25%, about 10% to about 25%, about 15% to about 25%, about 16% to about 25%, about 17% to about 25%, about 18% to about 25%, about 19% to about 25%, about 20% to about 25%, about 20% to about 24%, about 20% to about 23%, about 20% to about 22%, or about 21% of the composition by weight.

Alkali are the inorganic base reacting with the acid to provide the source of carbon dioxide. Of these salts, those of sodium and potassium are preferred due to good solubility and low cost. The alkali can be an alkali metal or alkaline earth metal carbonate, such as sodium carbonate, potassium carbonate, sodium bicarbonate, potassium bicarbonate, calcium carbonate and calcium bicarbonate.

In certain embodiments, the composition provided herein comprises alkali at about 0.5% to about 40%, about 1% to about 40%, about 5% to about 40%, about 10% to about 40%, about 15% to about 40%, about 20% to about 40%, about 25% to about 40%, about 30% to about 40%, about 35% to about 40%, about 38% of the composition by weight.

In certain embodiments, the alkali is a mixture of bicarbonates and carbonates, e.g., sodium bicarbonates and sodium carbonates, or potassium bicarbonates and potassium carbonate. The ratio between the bicarbonate and the carbonate may be in the range of about 1:10-10:1, about 1:5-10:1, about 1:3-10:1, about 1:2-10:1, about 1:1-10:1, about 2:1-10:1, about 3:1-10:1, about 3:1-9:1, about 3:1-8:1, about 3:1-7:1, about 3:1-6:1, about 3:1-5:1, about 3:1-4:1, about 3.5:1-4:1, or about 3.7:1 by weight.

In certain embodiments, the bicarbonate and carbonate are sodium bicarbonate and sodium carbonate, respectively, wherein the sodium bicarbonate is about 0.5% to about 40%, about 1% to about 40%, about 5% to about 40%, about 10% to about 40%, about 15% to about 40%, about 20% to about 40%, about 25% to about 40%, about 25% to about 35%, about 27% to about 33%, about 30% of the composition by weight and the sodium carbonate is about 1% to about 40%, about 1% to about 30%, about 1% to about 20%, about 2% to about 20%, about 3% to about 20%, about 3% to about 18%, about 3% to about 15%, about 3% to about 12%, about 3% to about 10%, about 5% to about 10%, about 6% to about 10%, about 7% to about 10%, or about 8% of the composition by weight. In certain embodiments, the bicarbonate and carbonate are potassium bicarbonate and potassium carbonate, respectively, wherein the potassium bicarbonate is about 0.5% to about 40%, about 1% to about 40%, about 5% to about 40%, about 10% to about 40%, about 15% to about 40%, about 20% to about 40%, about 25% to about 40%, about 25% to about 35%, about 27% to about 33%, about 30% of the composition by weight and the potassium carbonate is about 1% to about 40%, about 1% to about 30%, about 1% to about 20%, about 2% to about 20%, about 3% to about 20%, about 3% to about 18%, about 3% to about 15%, about 3% to about 12%, about 3% to about 10%, about 5% to about 10%, about 6% to about 10%, about 7% to about 10%, or about 8% of the composition by weight.

The ratio of bicarbonate and/or carbonate to the acid can be varied within wide limits. For example, the composition described herein may contain from 0.05 to 2 (e.g., 0.1, 0.2, 0.3, 0.4, 0.5, 0.55, 0.6, 0.7, 0.8, 0.9, 1, 1.1, 1.2, 1.3, 1.4, 1.5, 1.6, 1.7, 1.8, or 1.9) equivalents of water-soluble acidic substance per equivalent of bicarbonate and/or carbonate.

The term “equivalent” is used herein in the acid-base sense, with one gram molecular weight of solid acid being regarded as the equivalent of one gram molecular weight of NaHCO₃, or of 0.5 gram molecular weight of Na₂CO₃. However, lesser amounts may be employed and the amounts are not critical. It is only necessary that there be above about 0.05 equivalent of acid for each equivalent of bicarbonate. In other words when the alkali metal carbonate is a bicarbonate, any amount of acid in excess of 0.05 equivalent per equivalent of the bicarbonate is sufficient to cause some effervescence of the composition.

The composition disclosed herein comprises, by total weight, about 0.1% to about 20% (e.g., about 1% to about 15%, about 1% to about 10%, about 1% to about 8%, about 1% to about 7%, about 1% to about 6%, about 1% to about 5.5%, about 2% to about 5.5%, about 3% to about 5.5%, about 3%, or about 5.5%) of at least one binder. Binders bind the various components of the composition together to assist with the integrity of the composition and reduce the production of fines during the manufacture, packing, transport and delivery of the composition. Suitable binders include polyethylene glycol (PEG), maltose, trehalose, sorbitol, maltitol, polyvinylpyrrolidone (PVP), polyvinylpyrrolidone crosslinker (PVPP), dibasic calcium phosphate, sucrose, glucose, corn (maize) starch, modified cellulose, alginic acid, carboxymethylcellulose sodium, hydroxyl sodium methylcellulose, or copovidone, or a mixture thereof. In certain embodiments, the binder comprises PEG. In certain embodiments, the binder comprises at least one selected from the group consisting of PEG200, PEG1000, PEG2000, PEG4000, PEG6000, PEG8000, and PEG10000. In certain embodiments, the binder comprises PEG6000.

The composition disclosed herein comprises, by total weight, about 0.1% to about 50% (e.g., about 0.1% to about 45%, about 0.5% to about 45%, about 1% to about 45%, 1% to about 40%, about 1% to about 35%, about 1% to about 30%, about 5% to about 30%, about 8% to about 30%, about 10% to about 30%, about 15% to about 30%, about 20% to about 30%, about 25% to about 30%, about 5% to about 25%, about 5% to about 20%, about 5% to about 15%, or about 5% to about 10%) of at least one filler.

As used herein, the term “filler” refers to a substance added to a composition to increase the weight and/or the size of the composition. Several suitable fillers are known, and include but are not limited to sodium sulfate, ammonium sulfate, starch, bentonite, diatomaceous earth, kaolin, dextrin, maltodextrin, glucose, cellulose, microcrystalline cellulose, chitosan, lactose, lactose monohydrate, mannitol, sucrose, talcum, maltitol, sorbitol, xylitol, powdered cellulose, cellulose gum, starch, or calcium phosphate.

In certain embodiments, the composition provided herein comprises at least two fillers. In certain embodiments, the ratio between the first filler and the second filler can be varied in the range of about 1:10 to 10:1 (e.g. 1:9, 1:8, 1:7, 1:6, 1:5, 1:4.5, 1:4, 1:3.5, 1:3, 1:2, 1:1, 2:1, 3:1, 3.5:1, 4:1, 4.5:1, 5:1, 6:1, 7:1, 7:1, 8:1, or 9:1) by weight.

In certain embodiments, the fillers comprises talcum or maltodextrin, or a mixture thereof. In certain embodiments, the fillers comprises a mixture of talcum and maltodextrin. In certain embodiments, the ratio between talcum and maltodextrin is in the range of about 1:1-1:10, 1:1-1:9, 1:1-1:8, 1:1-1:7, 1:2-1:7, 1:2-1:6, 1:3-1:6, 1:3-1:5, 1:3-1:4, 1:4-1:5, 1:5, 1:4.5, 1:4, 1:3.5, 1:3, or 1:2 by weight. In some embodiments, the ratio between talcum and maltodextrin is about 1:3.3 by weight. In some embodiments, the ratio between talcum and maltodextrin is about 1:4.5 by weight.

Various minor ingredients can be added to the composition of the present disclosure but are not necessary. Examples of such minor ingredients are: lubricants such as magnesium stearate; bitters; perfume; optical brighteners; dyes; sodium carboxymethyl cellulose. The composition can also be coated with a water soluble film, such as a polyvinyl alcohol film, if desired.

A lubricant can be used to enhance release of a tablet from apparatus on which it is formed, for example by preventing adherence to the face of an upper punch (“picking”) or lower punch (“sticking”). Suitable lubricants include, for example, white carbon, talcum powder, magnesium stearate, calcium stearate, sodium stearate, zinc stearate, stearic acid, boric acid, metallic stearate, sodium stearyl fumarate, fatty acid, fatty alcohol, fatty acid ester, glyceryl behenate, canola oil, mineral oil, vegetable oil, glyceryl palmitostearate, hydrogenated vegetable oil, hydrogenated vegetable oil, magnesium oxide, poloxamer, paraffin, leucine, propylene glycol fatty acid ester, polyvinyl alcohol sodium benzoate, sodium lauryl sulfate, sodium stearyl fumarate, polyethylene glycol, polypropylene glycol, and polyalkylene glycol. Preferably, the lubricant comprises stearic acid and salts thereof, such as calcium, magnesium and aluminum stearate. In certain embodiments, the lubricant comprises magnesium stearate. In one embodiment, magnesium stearate is included as a lubricant in an amount of about 0.1% to about 5% (e.g., about 0.1% to about 4.5%, about 0.1% to about 4.0%, about 0.1% to about 3.5%, about 0.1% to about 3.0%, about 0.1% to about 2.5%, about 0.1% to about 2.0%, about 0.1% to about 1.5%, about 0.1% to about 1.0%, about 0.5% to about 1.0%, about 0.5% to about 0.7%, about 0.5%, or about 0.7%) of the composition by weight.

Bitters can also be used as aversive agents in the composition provided herein to discourage inappropriate ingestion by humans or non-target animals. Suitable bitters include but are not limited to benzodiazepine, denatonium, sucrose octaacetate, quercetin, brucine and quassin. In certain embodiments, the bitter comprises denatonium benzoate. In certain embodiments, the bitter is denatonium benzoate. In one embodiment, denatonium benzoate is included as a bitter in an amount of about 0.01% to about 5% (about 0.01% to about 4.5%, about 0.01% to about 4.0%, about 0.01% to about 3.5%, about 0.01% to about 3.0%, about 0.01% to about 2.5%, about 0.01% to about 2.0%, about 0.01% to about 1.5%, about 0.01% to about 1.0%, about 0.01% to about 0.5%, about 0.01% to about 0.4%, about 0.01% to about 0.3%, about 0.01% to about 0.2%, about 0.01% to about 0.1%, about 0.01% to about 0.05%, about 0.05%, about 0.1% of the composition by weight.

In certain embodiments, the composition provided herein does not substantially contain any organic solvent, e.g., in an amount of less than 10%, 5%, 3%, 1%, 0.5%, 0.2%, 0.1%, 0.05%, 0.01%, 0.001%, 0.0001%, 0.00001%, or 0.000001% of the composition by weight.

In certain embodiments, the composition does not substantially contain any dust within the tablet, e.g., in an amount of less than 10%, 5%, 3%, 1%, 0.5%, 0.2%, 0.1%, 0.05%, 0.01%, 0.001%, 0.0001%, 0.00001%, or 0.000001% of the composition by weight.

In certain embodiments, the composition may optionally contain one or more further active ingredients selected from herbicides, fungicides, bactericides, insecticides, nematocides, acaricides, and growth regulators.

In certain embodiments, the composition provided herein can be formulated as a tablet composition. In certain embodiments, each single tablet containing from about 0.0004 g to about 1 g, about 0.001 g to about 0.5 g, about 0.002 g to about 0.4 g, about 0.003 g to about 0.3 g, about 0.004 g to about 0.2 g, about 0.005 g to about 0.2 g, about 0.01 g to about 0.3 g, about 0.05 g to about 0.3 g, about 0.07 g to about 0.3 g, about 0.1 g to about 0.3 g, about 0.1 g to about 0.25 g, about 0.1 g to about 0.2 g, about 0.0034 g, about 0.0775 g, or about 0.15 g of the active ingredient component (a).

The term “tablet composition” as used herein refers to a solid form that can be prepared by molding or compaction of powders on a tablet press, as well known in the pharmaceutical arts.

The tablet composition of the present disclosure may be either homogeneous or heterogeneous. The term “homogeneous” as used herein refers to a tablet produced by molding or compaction of a single particulate composition, but does not imply that all the particles of that composition will necessarily be of identical composition. The term “heterogeneous” as used herein refers to a tablet with a plurality of discrete regions for example having layers, inserts or coatings around inserts.

The tablets can be prepared using conventional tablet-making equipment and can be of any suitable size and shape, for example round, oval, polygonal or pillow-shaped, and optionally bear nonfunctional surface markings. Tablets of the invention can be packaged in a container, accompanied by a package insert providing pertinent information such as, for example, dosage and application information, contraindications, precautions, drug interactions and adverse reactions.

The composition provided herein can be manufactured by known conventional method, preferably involves mixing ingredients, sifting and compression. Typically, a powder blend is prepared by mixing to homogeneity, passed through a sieve having a mesh size of mainly from about 70 to 200 mesh, and compressed in a tablet machine (e.g., a hydraulic press with a 5000 to 10000 pounds of force) to the desired tablet size and density.

In certain embodiments, the composition provided herein has a density greater than that of water (specific gravity greater than 1.00), such that the tablet will sink when contacting with water.

In the embodiments, the tablet of the disclosure may further comprise a coating, for example a nonfunctional coating. A nonfunctional coating can comprise a polymer component, for example HPMC, optionally with other ingredients, for example one or more plasticizers, colorants, etc. In such embodiments, tablets are to be subjected to an additional coating step after compression. The term “nonfunctional” as used herein refers to means having substantially no effect on release properties of the tablet, and should not be read to imply that the coating serves no useful purpose. For example, such a coating can impart a distinctive appearance to the tablet, provide protection against attrition during packaging and transportation, and/or have other benefits.

The tablet composition may be manufactured to any size that is appropriate for its application. In certain embodiments, the tablet is about 0.01 g to about 20 g, about 0.05 g to about 20 g, about 0.1 g to about 20 g, about 0.2 g to about 20 g, about 0.5 g to about 20 g, about 0.5 g to about 15 g, about 0.5 g to about 10 g, about 1 g to about 10 g, about 1 g to about 5 g, about 2 g to about 5 g, about 3 g to about 5 g, about 3 g to about 4.5 g, about 3 g to about 4 g, about 3.0 g to 3.4 g.

In certain embodiments, the tablet has a diameter of about 5 mm to about 100 mm, about 5 mm to about 50 mm, about 5 mm to about 40 mm, about 5 mm to about 35 mm, about 5 mm to about 30 mm, about 10 mm to about 15 mm, about 10 mm to about 30 mm, about 15 mm to about 30 mm, about 20 mm to about 30 mm, about 20 mm to about 25 mm, about 20 to about 22 mm, about 20 mm or about 22 mm.

In certain embodiments, the composition provided herein has a pH value in the range from 5.0 to 8.0, optionally from 6.0 to 7.0, when the composition is diluted in water at 1% by weight. In certain embodiments, the composition provided herein has a pH value of about 6.5, 6.7 or 6.8 (1% diluted in water by weight).

Hardness is a measurement of the force required to cause crushing of the compact under the conditions of storage, transportation, and handling before usage, and is typically expressed in units such as kiloponds (kp), Strong-Cobb units (SCU) or Newton (N). A hardness of about 1 SCU represented roughly 0.7 kp of force or about 7 N. An uncoated tablet, or a tablet core prior to coating, comprising at least one filler provided herein acting as a matrix for a water-soluble pesticide may need to have a certain minimum hardness in order to be able to resist breakage and/or attrition due to mechanical stresses imposed during a high-speed tableting operation (including all steps up to and including filling of the tablets into containers). The minimum acceptable hardness will depend on a number of factors, including the severity of the mechanical stresses, but is typically at least about 70 N (e.g., more than 80 N, 90 N, 100 N, or 105 N). In certain embodiments, the tablet composition provided herein has a tablet hardness of 106, 79, or 75 N.

The formulation ingredients may be dry before being blended, milled and compacted. Drying at 45 to 60° C. for 16 hours in a vacuum oven is sufficient to reduce the water content of the premix to below about 3.0%. This is helpful so that residual moisture does not initiate the effervescence reaction during storage. The ingredients are typically ground and mixed in a mill, e.g., an air or hammermill. The ground premix is brushed through a 70 to 200 mesh screen. In certain embodiments, the water content of the composition is less than 3.0%, 2.5%, 2.0%, 1.9%, 1.8%, 1.7%, 1.6%, 1.5%, 1.0%, or 0.5%.

The present disclosure also provides a method of controlling pests in a crop, which comprises applying an agriculturally effective amount of the composition to a crop in need thereof or to its environment.

The term “agriculturally effective amount” as used herein refers to the quantity or application rate of a pesticide composition which, when applied to crops or pasture, will kill or substantially injure a significant portion of the pest or weed or fungus population residing therein, and/or substantially reduce damage to crops or pasture at any stage of growth cycle.

In certain embodiments, the crop is agronomic or nonagronomic.

The term “agronomic crop” refers to field crops such as those for food and fiber and includes corn; soybeans and other legumes; cereal (e.g., wheat, oats, barley, rye, rice, and maize); vegetables, for example, leafy vegetables (e.g., lettuce, cabbage, and other cole crops), fruiting vegetables (e.g., tomatoes, pepper, eggplant, crucifers and cucurbits), potatoes, sweet potatoes; cotton; fruits, grapes, tree fruits (e.g., pome, stone and citrus), small fruit (e.g., berries and cherries); and other specialty crops (e.g., canola, sunflower and olives).

The term “nonagronomic crop” refers to other horticultural crops (e.g., greenhouse, nursery or ornamental plants not grown in a field, plants in residential and commercial structures in urban and industrial settings), turf (e.g., sod farm, pasture, golf course, lawn, residential, recreational and sports field), wood products, stored products, agro-forestry and vegetation for public health (i.e., human) and animal health (e.g., pets, livestock, poultry, and non-domesticated animals such as nature animals) applications.

Invertebrate pests are controlled in agronomic and nonagronomic applications by applying the composition provided in this disclosure, in an effective amount, to the environment of the pests, including the agronomic and/or nonagronomic locus of infestation, to the area to be protected, or directly on the pests to be controlled.

The term “invertebrate pest” as used herein encompasses arthropods, gastropods and nematodes of economic importance as pests. The term “arthropod” encompasses insects, mites, spiders, scorpions, centipedes, millipedes, pill bugs and symphylans. The term “gastropod” encompasses snails, slugs and other Stylommatophora. The term “nematode” encompasses all of the helminths, such as: roundworms, heartworms, and phytophagous nematodes (Nematoda), flukes (Tematoda), Acanthocephala, and tapeworms (Cestoda).

Agronomic applications include protecting a field crop from invertebrate pests typically by applying a composition or a mixture of the compositions of the present disclosure to the seed of the crop before the planting, in furrow during seeding, to the foliage, stems, flowers and/or fruit of crop plants, or to the soil or other growth medium (e.g., paddy) before or after the crop is planted or while the crop is being planted. Nonagronomic applications refer to invertebrate pest control in the areas other than on crop plants. Nonagronomic applications include control of invertebrate pests in stored grains, beans and other foodstuffs, and in textiles such as clothing and carpets. Nonagronomic applications also include invertebrate pest control in ornamental plants, forests, in yards, along road sides and railroad rights of way, and on turf such as lawns, golf courses and pastures. Nonagronomic applications also include invertebrate pest control in houses and other buildings which may be occupied by humans and/or companion, farm, ranch, zoo or other animals. Nonagronomic applications also include the control of pests such as termites that can damage wood or other structural materials used in buildings. Nonagronomic applications also include protecting human and animal health by controlling invertebrate pests that are parasitic or transmit infectious diseases. Such pests include, for example, chiggers, ticks, lice, mosquitoes, flies and fleas.

One embodiment of the composition application is by spraying. Alternatively, a tablet composition comprising a composition of the present disclosure can be applied to the plant foliage or the soil. The compositions of the present disclosure are also effectively delivered through plant uptake by contacting the plant with the composition of the present disclosure applied as a soil drench of a tablet formulation to the soil, a nursery box treatment or a dip of transplants. In certain embodiments, the crop is rice and the composition is applied in a paddy field. In certain embodiments, the composition is manually or mechanically scattered onto a paddy field, i.e., by manually throwing from a path between the paddy fields without entering into the paddy fields or can be thrown from a paddy field.

The method is applicable to any cropping situation where control is required for pests or pests' life stages. The method can be useful when combined with sowing or transplant operations, but can also be used with mature crops, particularly established paddy field.

Pests that may be controlled by the composition include, but are not limited to, larvae of the order Lepidoptera, such as armyworms, cutworms, loopers, and heliothines in the family Noctuidae (e.g., fall armyworm (Spodoptera fugiperda J. E. Smith), beet armyworm (Spodoptera exigua Hübner), black cutworm (Agrotis ipsilon Hufnagel), cabbage looper (Trichoplusia ni Hübner), and tobacco budworm (Heliothis virescens Fabricius)); borers, casebearers, webworms, coneworms, cabbageworms and skeletonizers from the family Pyralidae (e.g., European corn borer (Ostrinia nubilalis Hübner), navel orangeworm (Amyelois transitella Walker), corn root webworm (Crambus caliginosellus Clemens), and sod webworm (Herpetogramma licarsisalis Walker)); leafrollers, budworms, seed worms, and fruit worms in the family Tortricidae (e.g., codling moth (Cydia pomonella L. (L. means Linnaeus)), grape berry moth (Endopiza viteana Clemens), and oriental fruit moth (Grapholita molesta Busck)); and many other economically important lepidoptera (e.g., diamondback moth (Plutella xylostella L. of family Plutellidae), pink bollworm (Pectinophora gossypiella Saunders of family Gelechiidae), and gypsy moth (Lymantria dispar L. of family Lymantriidae)); foliar feeding larvae and adults of the order Coleoptera including weevils from the families Anthribidae, Bruchidae, and Curculionidae (e.g., boll weevil (Anthonomus grandis Boheman), rice water weevil (Lissorhoptrus oryzophilus Kuschel), and rice weevil (Sitophilus oryzae L.)); flea beetles, cucumber beetles, rootworms, leaf beetles, potato beetles, and leafminers in the family Chrysomelidae (e.g., Colorado potato beetle (Leptinotarsa decemlineata Say), and western corn rootworm (Diabrotica virgifera LeConte)); chafers and other beetles from the family Scaribaeidae (e.g., Japanese beetle (Popillia japonica Newman) and European chafer (Rhizotrogus majalis Razoumowsky)); wireworms from the family Elateridae and bark beetles from the family Scolytidae; adults and larvae of the order Dermaptera including earwigs from the family Forficulidae (e.g., European earwig (Forficula auricularia L.) and black earwig (Chelisoches morio Fabricius)); adults and nymphs of the orders Hemiptera and Homoptera such as, plant bugs from the family Miridee, cicadas from the family Cicadidae, leafhoppers (e.g., Empoasca spp.) from the family Cicadellidae, planthoppers from the families Fulgoroidae and Delphacidae, treehoppers from the family Membracidae, psyllids from the family Psyllidae, whiteflies from the family Aleyrodidae, aphids from the family Aphididae, phylloxera from the family Phylloxeridae, mealybugs from the family Pseudococcidae, scales from the families Coccidae, Diaspididae and Margarodidae, lace bugs from the family Tingidae, stink bugs from the family Pentatomidae, cinch bugs (e.g., Blissus spp.) and other seed bugs from the family Lygaeidae, spittlebugs from the family Cercopidae, squash bugs from the family Coreidae, and red bugs and cotton stainers from the family Pyrrhocoridae; adults and immatures of the order Orthoptera including grasshoppers, locusts and crickets (e.g., migratory grasshoppers (e.g., Melanoplus sanguinipes Fabricius and M. differentialis Thomas), American grasshoppers (e.g., Schistocerca americana Drury), desert locust (Schistocerca gregaria Forskal), migratory locust (Locusta migratoria L.), and mole crickets (Gtyllotalpa spp.)); adults and immatures of the order Diptera, including leafminers, midges, fruit flies (Tephritidae), frit flies (e.g., Oscinella frit L.), soil maggots and other Nematocera; adults and immatures of the order Thysanoptera including onion thrips (Thrips tabaci Lindeman) and other foliar feeding thrips.

In certain embodiments, the pests that can be controlled by the composition include, but are not limited to, Lissorhoptrus oryzophilus, fall armyworm, Spodoptera frugiperda, sugarcane borer, diatrea saccharalis, scirpophaga incertulas, chilo polychrysa, sesamia inferens, Nephotettix virescens, nephotettix nigropictus, Nilaparvata lugens, leptocarisa acuta, Sogatella furcifera, recilla dorsalis, thrips oryzae, mythimna separata, Spodoptera mauritia, dicladispa armigera, cnaphalocrisis medinalis, Nymphyla depunctalis, Parnara guttata and orseolia oryzae.

The rate of application required for effective control (i.e., “agriculturally effective amount”) will depend on factors such as the active ingredient, the operator, the species of invertebrate to be controlled, the pest's life cycle, life stage, its size, location, time of year, host crop or animal feeding behavior, mating behavior, the density and pattern of seedling or planting of the crop, ambient moisture, temperature, and whether the composition is applied as a preventative or salvage operation. Under normal circumstances, the composition may be applied in agronomic ecosystems at a rate ranging from about 10 grams active ingredient per hectare (gai/ha) to about 10,000 gai/ha (e.g., about 10 to about 5000 gai/ha, about 10 to about 1000 gai/ha, about 10 to about 500 gai/ha, about 10 to about 200 gai/ha, about 10 to about 100 gai/ha, about 10 to about 90 gai/ha, about 10 to about 80 gai/ha, about 10 to about 70 gai/ha, about 10 to about 60 gai/ha, about 10 to about 50 gai/ha, about 20 to about 50 gai/ha, about 30 to about 50 gai/ha, or about 40 gai/ha), but as little as 0.1 gai/ha may be sufficient or as much as 80,000 gai/ha may be required. In certain embodiments, the composition is applied at a rate about 40 gai/ha. For nonagronomic applications, effective use rates will range from about 1.0 to 50 mg/square meter (m²) (e.g., about 1-40 mg/m², about 1-35 mg/m², about 1-30 mg/m², about 1-25 mg/m2, about 1-20 mg/m², about 1-15 mg/m², about 1-10 mg/m², or about 1-5 mg/m²), but as little as 0.1 mg/m² may be sufficient or as much as 150 mg/m² may be required. One skilled in the art can easily determine the agriculturally effective amount necessary for the desired level of invertebrate pest control.

### EXAMPLE

The invention will be described in greater detail by way of specific examples. The following examples are offered for illustrative purposes, and are not intended to limit the invention in any manner. Those of skilled in the art will readily recognize a variety of noncritical parameters which can be changed or modified to yield essentially the same results.

### Example 1. Anthranilamide Tablets Screening

Preparation

The tablets tested in examples were prepared according to the following steps: all ingredients were weighed and completely mixed and underwent the mesh to give particles ranged in 70 to 200 mesh before being pressed by 60 kilo Newton (kN) tablet press. The resultant tablets weighing 3.0-3.5 g and having a diameter of about 20-22 mm, were formed then.

Preliminary Screening

Before screening the enhancer and dispersing agent for use in the chlorantraniliprole-contained formulation, the following preliminary screening procedures were performed.

Acids and alkalis. Different combinations of acids and alkalis were screened in terms of (a) the ability to generate desirable amount of effervescence that lasts a desirable period of time upon contacting with water and facilitates full dispersion of the active ingredient in the water where the plant grows, (b) cost, and (c) industrial processability (such as from a safety perspective). Based on the screening, the preferred combination of acids and alkalis were identified and used in following examples.

Lubricant, binder and filler. Different kinds of lubricants, binders and fillers were screened. Based on the screening, the preferred lubricants, binders and fillers were identified and used in following examples.

Enhancer and Dispersing Agent Screening

Tablets with different recipes (comprising, e.g., both enhancer and dispersing agent, only enhancer, only dispersing agent or different types of enhancer and dispersing agent) were prepared and compared in term of bubble degree and diffusion rate of the tablets upon contact with the water. Bubble degree was examined through visual sense and pigment was used to track the diffusion of the tablets. The recipes and results are summarized in the following Table 1. It can be seen that, Recipe 1-4, Recipe 1-5 and Recipe 1-7 showed better performance than remaining recipes in term of the bubble degree and diffusion rate, which is indicative of the symbol +, the more + the better performance.

TABLE 1

| | | | Recipe | | | | | | | |
|---|---|---|---|---|---|---|---|---|---|---|
| | | | 1-2 | 1-3 | 1-4 | 1-5 | 1-6 | 1-7 | 1-8 | 1-9 |
| No. | Ingredients | Function | (g) | (g) | (g) | (g) | (g) | (g) | (g) | (g) |
| 1 | Chlorantraniliprole | Active | 1 | 1 | 1 | 1 | 1 | 1 | 1 | 1 |
| | | Ingredient | | | | | | | | |
| | | (AI) | | | | | | | | |
| 2 | Geropon SDS | Enhancer | 0.8 | 0.8 | 0.8 | 0.8 | / | / | / | / |
| | sodium lauryl sulfate | | / | / | / | / | 3 | / | / | 1 |
| | Supragil WP | | / | / | / | / | / | 1 | 1 | / |
| 3 | Tersperse 2700 | Dispersing | / | 1.5 | 2.5 | 3.5 | / | 2.5 | / | / |
| | Polyfon H | agent | / | / | / | / | / | / | / | 4 |
| | Morwet D-425 | | / | / | / | / | / | / | 4 | / |
| 4 | D,L-tartaric acid | Acid | 21 | 21 | 21 | 21 | 21 | 21 | 21 | 21 |
| 5 | Sodium bicarbonate | Alkali | 30 | 30 | 30 | 30 | 30 | 30 | 30 | 30 |
| 6 | Sodium carbonate | Alkali | 8 | 8 | 8 | 8 | 8 | 8 | 8 | 8 |
| 7 | Magnesium stearate | Lubricant | 0.5 | 0.5 | 0.5 | 0.5 | 0.5 | 0.5 | 0.5 | 0.5 |
| 8 | Denatonium benzoate | Bitter | 0.05 | 0.05 | 0.05 | 0.05 | 0.05 | 0.05 | 0.05 | 0.05 |
| 9 | PEG-6000 | Binder | 3 | 3 | 3 | 3 | 3 | 3 | 3 | 3 |
| 10 | Talcum | Filler | 6 | 6 | 6 | 6 | 6 | 6 | 6 | 6 |
| 11 | Red pigment | Color | 1 | 1 | 1 | 1 | 1 | 1 | 1 | 1 |
| | | reagent | | | | | | | | |
| 12 | Maltodextrin | Filler | to | to | to | to | to | to | to | to |
| | | | 100 | 100 | 100 | 100 | 100 | 100 | 100 | 100 |
| Testing | Bubble degree | | +++ | +++ | +++ | +++ | +++ | +++ | +++ | +++ |
| method | Diffusion rate | | + | ++ | +++ | +++ | + | +++ | ++ | + |

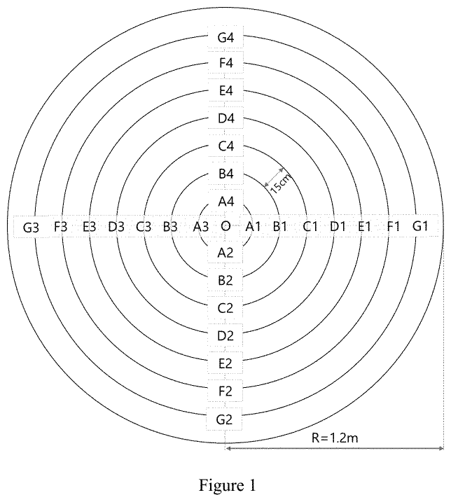

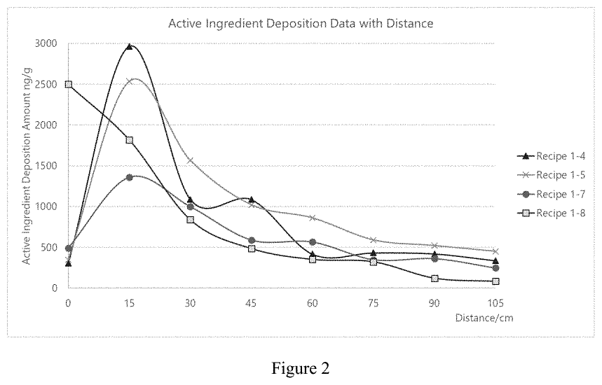

Recipes 1-4, Recipe 1-5, Recipe 1-7 and Recipe 1-8 were further examined for the distribution profile by the following method: (a) one round pool with the radius of 1.2 m was provided, and a watch glass was placed under each of the sampling positions as showed in FIG. 1, wherein the distance between each two neighboring peripheries is 15 cm, 4 spots (such as A1, A2, A3 and A4) evenly located on one periphery were selected as sampling position; (b) filled the pool with about 5 cm depth of tap water; (c) threw one tablet (3 g) into the pool; (d) 30 mins later, covered the watch glass and took out from the pool; (e) analyzed the content of the active ingredients (including the active ingredients dissolved and suspended in water and deposited onto the glass watch) in the collected watch glass through IPLC; (e) calculated the average of the active ingredients collected from the 4 pots. The results were showed in FIG. 2. It can be seen that the tablets with both the enhancer comprising sodium dialkylsulfosuccinate and the dispersing agent comprising polycarboxylate (namely Recipes 1-4, 1-5 and 1-7) achieved much better effect compared with other recipes.

### Example 2. New Anthranilamide Tablets

Based on the screening in Example 1, the recipe was further optimized and a bitter or aversive agent was added to the tablet composition to prevent accidental swallowing by human or animals. The optimized recipes with different concentrations of chlorantraniliprole (Rynaxypyr@ A1) are shown in Table 2. Tablets were prepared in the same manner as described in Example 1.

TABLE 2

| | | Chlorantraniliprole tablet | | | | | | | |
|---|---|---|---|---|---|---|---|---|---|
| Ingredients | Function | 1.0% | | 2.5% | | 5.0% | | 5.0% | |
| Chlorantraniliprole | Active ingredient | 1.05 | g | 2.6 | g | 5.1 | g | 5.1 | g |
| tablet (98%) | (AI) | | | | | | | | |
| Geropon ® SDS | Enhancer | 0.8 | g | 0.8 | g | 0.8 | g | 0.8 | g |
| Tersperse ® 2700 | Dispersing agent | 2.5 | g | 2.5 | g | 2.5 | g | 2.5 | g |
| D,L-tartaric acid | Acid | 21 | g | 21 | g | 21 | g | 21 | g |
| Sodium bicarbonate | Alkali | 30 | g | 30 | g | 30 | g | 30 | g |
| Sodium carbonate | Alkali | 8 | g | 8 | g | 8 | g | 8 | g |
| Magnesium stearate | Lubricant | 0.5 | g | 0.7 | g | 0.7 | g | 0.7 | g |
| Denatonium | Bitter | 0.05 | g | 0.05 | g | 0.05 | g | 0.1 | g |
| benzoate | | | | | | | | | |
| Polyfon H | Dispersant | 0 | | 0 | | 0 | | 1 | |
| PEG-6000 | Binder | 3.0 | g | 5.5 | g | 5.5 | g | 5.5 | g |
| Talcum | Filler | 6.0 | g | 6.0 | g | 6.0 | g | 6.0 | g |

| | | | | | |
|---|---|---|---|---|---|
| Maltodextrin | Filler | To 100 g | To 100 g | To 100 g | To 100 g |

Distribution Profile Analysis

Using the same method as descried in Example 1 to examine the distribution profile of the tablets in Table 2. It was found that the tablets in Table 2 achieved improved effect.

Stability Test

The stability of the tablets in Table 2 were tested after storage for 14 days. The data are shown in Table 3

TABLE 3

| | 1.0% | | 2.5% | | 5.0% | |
|---|---|---|---|---|---|---|
| | Chlorantraniliprole | | Chlorantraniliprole | | Chlorantraniliprole | |
| | tablet | | tablet | | tablet | |
| | Initial | 54° C./14 days | Initial | 54° C./14 days | Initial | 54° C./14 days |
| Appearance | White | White | White | White | White | White |
| | uniform | uniform | uniform | uniform | uniform | uniform |
| | tablets | tablets | tablets | tablets | tablets | tablets |
| AI Content (%) | 0.99 | 0.97 | 2.51 | 2.53 | 5.1 | 5.06 |
| pH (1% Dilution | 6.5 | 6.5 | 6.7 | 6.6 | 6.8 | 6.9 |
| in Water) | | | | | | |
| Tablet Hardness | 106 | 125 | 79 | 106 | 75 | 100 |
| Degree of Attrition | 1.20% | 0.80% | 1.20% | 0.6% | 1.20% | 0.8% |
| Water Content (%) | 1.90% | 1.60% | 1.70% | 1.2% | 1.90% | 1.6% |

Efficacy Analysis (21 Days after Tablet Application)

Rice seedlings were transplanted to the paddy fields at 4.5 leaf stage and grew for 7 days to allow the seedlings to turn green before the insecticide application. The chlorantraniliprole tablets in Table 2 and the commercially available chlorantraniliprole products Ferterra® and CORAGEN® (for references) were separately applied into the selected fields with consistent field conditions. The tablets and Ferterra® were both applied through broadcast application and CORAGEN® was applied through foliar application. Chlorantraniliprole tablets and Ferterra® were generally applied uniformly 7 days after rice transplanting at the application rate of 40 gai/ha. CORAGEN® was usually mixed with water and applied via foliar application at the initial stage of the egg hatching of striped stem borer at the rate of 30 gai/ha. One control check (without any treatment, “CK”) paddy field was selected for efficacy referencee. The efficacy of the tablets was further investigated 21 days after the tablet application. The whole plot survey was adopted to count the rice seedlings showing dead heart caused by the striped rice borers in each application plot, and the efficacy was calculated by the following formula:

Efficacy %=((Number of dead heart in CK group)−(Number of dead heart in treatment group))/(Number of dead heart in CK group)*100.

The results are shown in Table 4.

TABLE 4

| Formulation Type | 21 Days Efficacy |
|---|---|
| 1% chlorantraniliprole tablets | 93.21 |
| 2.5% chlorantraniliprole tablets | 92.52 |
| 5% chlorantraniliprole tablets | 95.39 |
| Ferterra ® | 93.70 |
| CORAGEN ® | 92.25 |

The results shown in Table 4 indicated that the chlorantraniliprole tablets applied at 40 gai/ha can effectively control rice stem borer. 1% chlorantraniliprole tablets, 2.5% chlorantraniliprole tablets and 5% chlorantraniliprole tablets achieved similar or even slightly better control than both the granules (Ferterra®) and the suspending concentrate (“SC”, CORAGEN®) containing the same dose of chlorantraniliprole, while the application of tablets formulation were more labor-saving.

Active Ingredient Chlorantraniliprole Residue in Body Test in Field

1% chlorantraniliprole tablet (4 g), 2.5% chlorantraniliprole tablet (1.6 g), 5% chlorantraniliprole tablet (0.8 g), Ferterra® (calculated to 0.04 gai/25 m², 0.4% Granules), and CORAGEN® (calculated to 0.04 gai/25 m², 200 g/L SC) were applied into 5*5 m plot. The rice seedlings were sampled at 3 days (3DAA) and 20 days (20DAA) after the formulation application. As the striped stem borers mainly attack the rice stem, the chlorantraniliprole residue in rice stem was tested to verify the absorption of active ingredient, which could be ingested by the striped borers and cause poisoning. In order to extract the active ingredient chlorantraniliprole, the rice seedling was cut and the stem was picked out and dipped into acidic acetonitrile for 24 hours. The resultant solution was further shaken for 2 hours, and then filtered and analyzed through GC-MS to measure the amount of the active ingredient chlorantraniliprole absorbed by the rice seedlings.

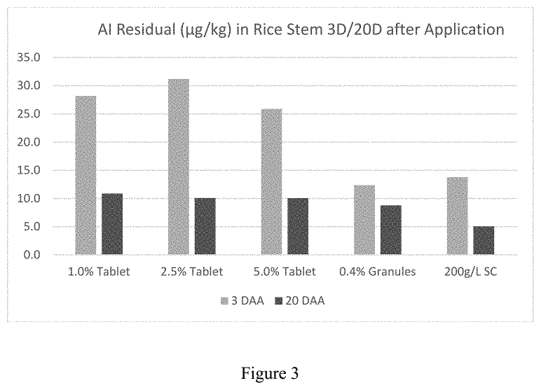

The residue of chlorantraniliprole in rice (g/kg) is summarized in Table 5 and illustrated in FIG. 3 according to the test results of GC-MS. The seedlings applied with 1% chlorantraniliprole tablet (4 g), 2.5% chlorantraniliprole tablet (1.6 g), or 5% chlorantraniliprole tablet (0.8 g) absorbed higher amounts of active ingredients chlorantraniliprole than those applied with Ferterra® or CORAGEN® at 3 days and 20 days after the formulation application, suggesting that tablets formulation comprising the claimed enhancer and dispersing agent dispersed more effectively in the paddy water.

TABLE 5
AI Residual in Rice Stem (μg/kg)

| | 3 DAA | 20 DAA |
|---|---|---|
| 1.0% Tablet | 28.2 | 10.9 |
| 2.5% Tablet | 31.2 | 10.1 |
| 5.0% Tablet | 25.9 | 10.1 |
| 0.4% Granules | 12.4 | 8.8 |
| 200 g/L SC | 13.8 | 5.1 |

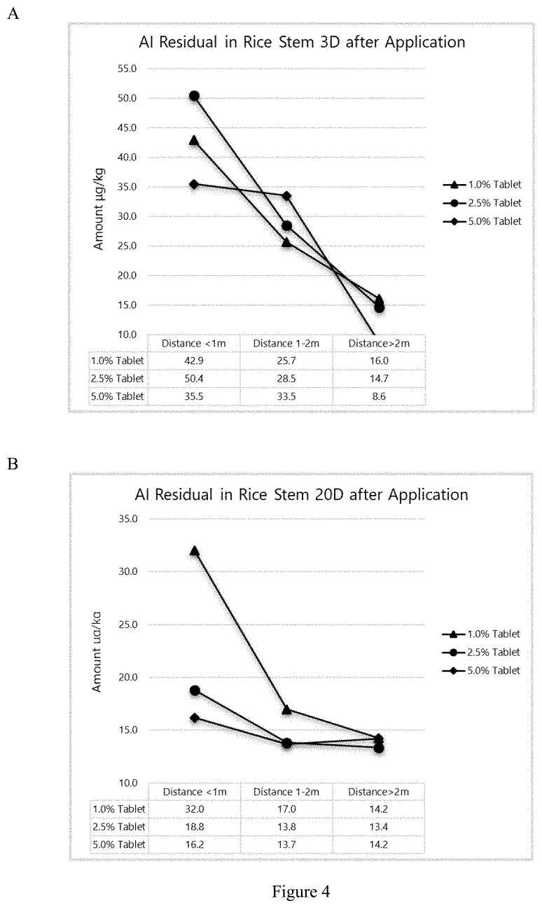

The concentration of chlorantraniliprole in the seedlings collected at different distances from the site of application were measured as described above and the results are summarized in Table 6 and Table 7, and shown in FIG. 4.

TABLE 6
AI Residual in Rice Stem 3 Days after Application (μg/kg)

| Formulation | Distance <1 m | Distance 1-2 m | Distance >2 m |
|---|---|---|---|
| 1.0% Tablet | 42.9 | 25.7 | 16.0 |
| 2.5% Tablet | 50.4 | 28.5 | 14.7 |
| 5.0% Tablet | 35.5 | 33.5 | 8.6 |

TABLE 7
AI Residual in Rice Stem 20 days after application (μg/kg)

| Formulation | Distance <1 m | Distance 1-2 m | Distance >2 m |
|---|---|---|---|
| 1.0% Tablet | 32.0 | 17.0 | 14.2 |
| 2.5% Tablet | 18.8 | 13.8 | 13.4 |
| 5.0% Tablet | 16.2 | 13.7 | 14.2 |

### Example 3. More Tablets

Several tablets, which contain similar ingredients as the tablets in Table 2 but different pesticidal active ingredients, are prepared. It is expected that those tablets comprising the claimed enhancer and dispersing agent can achieve improved effects similar to those of the tablets in Table 2 in terms of diffusivity and penetration.

The present invention may also broadly be said to consist in the parts, elements and features referred or indicated in the specification, individually or collectively, and any or all combinations of any of two or more parts, elements, members or features and where specific integers are mentioned herein which have known equivalents such equivalents are deemed to be incorporated herein as if individually set forth.

The invention has been described with particular reference to certain embodiments thereof. It will be understood that various modifications can be made to the above-mentioned embodiment without departing from the ambit of the invention. The skilled person in the art will also understand the concept of what is meant by purposive construction.

1. A formulation comprising a composition comprising:
(a) a pesticidal active ingredient;
(b) an enhancer, wherein the enhancer comprises a salt of dialkylsulfosuccinate, a salt of lauryl sulfate, a salt of lauryl benzene sulfonate, fatty alcohol derivative, a salt of alkyl naphthyl sulphonate, or a salt of alkylnaphthyl sulphate, or a mixture thereof;
(c) a dispersing agent, wherein the dispersing agent comprises polycarboxylate, phenol sulfonic acid condensation, polyoxypropylene-polyoxyethylene block copolymer, or naphthalene sulfonic acid condensation, or a mixture thereof;
(d) a binder; and
(e) optionally a filler.

2. A-The-formulation of claim 1 wherein the composition comprises by weight based on the total weight of the composition:
(a) about 0.1% to about 20% of the pesticidal active ingredient;
(b) about 0.1% to about 5% of the enhancer;
(c) about 0.1% to about 10% of the dispersing agent;
(d) about 0.1% to about 20% of the binder; and
(e) about 0.1% to about 50% of the filler.

3. A tablet composition comprising the formulation of claim 1.

4. (canceled)

5. The formulation of claim 1 or 2, wherein the pesticidal active ingredient is a herbicide or insecticide, or a mixture thereof.

6. The formulation of claim 1 or 2, wherein the pesticidal active ingredient is a diamide, neonicotinoid, or nereistoxin analogue insecticide, or a mixture thereof.

7. The formulation of claim 1 or 2, wherein the component (a) comprises chlorantraniliprole, cyantraniliprole, tetraniliprole, cyclaniliprole, cyhalodiamide, tetra-chlorantraniliprole, bromoantraniliprole, dichlorantraniliprole, thiamethoxam, clothianidin, thiacloprid, monosultap, or bisultap, or a mixture thereof, optionally, wherein the component (a) comprises chlorantraniliprole.

8. The formulation of claim 1 or 2, wherein the component (b) comprises Geropon® SDS, Aerosol® OT-B, or Aerosol® OT-75, or a mixture thereof, optionally, wherein the component (b) comprises Geropon® SDS.

9. The formulation of claim 1 or 2, wherein the component (c) comprises Tersperse® 2700, Atlox Metasperse™ 550S, Geropon® Ultrasperse, Duramax® D-205, or Geropon® T/36, or a mixture thereof, optionally, wherein the component (c) comprises Tersperse® 2700.

10. The formulation of claim 1 or 2, wherein the component (d) comprises at least one substance selected from the group consisting of polyethylene glycol (PEG), maltose, trehalose, sorbitol, maltitol, polyvinylpyrrolidone, dibasic calcium phosphate, sucrose, glucose, corn (maize) starch, modified cellulose, alginic acid, carboxymethylcellulose sodium, and copovidone, optionally, the component (d) comprises PEG, optionally, the component (d) comprises at least one PEG selected from the group consisting of PEG2000, PEG4000, PEG6000, PEG8000 and PEG10000, optionally, the component (d) comprises PEG 6000.

11. The formulation of claim 1 or 2, wherein the component (e) comprises at least one substance selected from the group consisting of lactose, lactose monohydrate, mannitol, sucrose, talcum, maltodextrin, dextrin, maltitol, sorbitol, xylitol, powdered cellulose, cellulose gum, microcrystalline cellulose, starch, and calcium phosphate; optionally, the component (e) comprises talcum or maltodextrin, or a mixture thereof, optionally, the component (e) comprises a mixture of talcum and maltodextrin, optionally, wherein the talcum when used is about 1% to about 15%, about 1% to about 10%, about 1% to about 8%, about 2% to about 8%, about 3% to about 8%, about 4% to about 8%, about 5% to about 8%, about 6% to about 8%, or about 6% of the composition by weight, and the maltodextrin when used is about 1% to about 40%, about 1% to about 30%, about 5% to about 30%, about 8% to about 30%, about 10% to about 30%, about 15% to about 30%, about 18% to about 30%, about 18% to about 27%, or about 20% to about 27% of the composition by weight.

12. The formulation of claim 1 or 2, the formulation or the composition further comprises by weight based on the total weight of the composition: component (f) about 0.1% to about 40% of at least one acid and (g) about 0.1% to about 40% of at least one alkali.

13. The formulation of claim 1 or 2, wherein the composition further comprises by weight based on the total weight of the composition: component (h) about 0.1% to about 5% of at least one lubricant.

14. The formulation of claim 1 or 2, wherein the composition further comprises by weight based on the total weight of the composition: component (i) about 0.01% to about 5% of at least one bitter.

15.-19. (canceled)

20. A method for controlling pests in a crop, comprising applying an agriculturally effective amount of the formulation of claim 1 or 2 to a crop in need thereof or its environment.

21. The method of claim 20, wherein the crop is rice and the formulation or composition is applied to a paddy field.

22. (canceled)

23. The tablet composition of claim 3, wherein the pesticidal active ingredient is a herbicide or insecticide, or a mixture thereof.

24. The tablet composition of claim 3, wherein the pesticidal active ingredient is a diamide, neonicotinoid, or nereistoxin analogue insecticide, or a mixture thereof.

25. The tablet composition of claim 3, wherein the component (a) comprises chlorantraniliprole, cyantraniliprole, tetraniliprole, cyclaniliprole, cyhalodiamide, tetra-chlorantraniliprole, bromoantraniliprole, dichlorantraniliprole, thiamethoxam, clothianidin, thiacloprid, monosultap, or bisultap, or a mixture thereof, optionally, wherein the component (a) comprises chlorantraniliprole.

26. The tablet composition of claim 3, wherein the component (b) comprises Geropon® SDS, Aerosol® OT-B, or Aerosol® OT-75, or a mixture thereof, optionally, wherein the component (b) comprises Geropon® SDS.
